(19) United States
(12) Patent Application Publication
(10) Pub. No.: US 2025/0380177 A1
(43) Pub. Date: Dec. 11, 2025

(54) WIRELESS COMMUNICATION METHOD, AND DEVICE

(71) Applicant: GUANGDONG OPPO MOBILE TELECOMMUNICATIONS CORP., LTD., Dongguan (CN)

(72) Inventors: Zhe FU, Dongguan (CN); Bingxue LENG, Dongguan (CN); Qianxi LU, Dongguan (CN)

(21) Appl. No.: 19/309,777

(22) Filed: Aug. 26, 2025

Related U.S. Application Data
(63) Continuation of application No. PCT/CN2023/090992, filed on Apr. 26, 2023.

(51) Int. Cl. H04W 28/02; H04W 92/18

(52) U.S. Cl. CPC H04W 28/02; H04W 92/18

(57) ABSTRACT

A wireless communication method includes: performing, by a receiving end, a first operation according to bi-directional QoS requirement information on a sidelink, where the first operation includes at least one of: determining a PDB of a reverse link, adjusting the PDB of the reverse link, determining a PSDB of the reverse link, adjusting the PSDB of the reverse link, determining a remaining delay, determining a remaining delay of the reverse link, deleting packets, recommending a PSDB of a forward link, recommending a PDB of the forward link, adjusting a selected resource, adjusting a selected resource set, selecting a transmission resource, selecting a transmission resource set, recommending an optional resource for a transmitting end, recommending an optional resource set for the transmitting end, triggering feedback, performing feedback, obtaining or determining time information, obtaining or determining delay information, or obtaining or determining auxiliary information.

### CROSS-REFERENCE TO RELATED APPLICATION

This application is a Continuation application of International Application No. PCT/CN2023/090992 filed on Apr. 26, 2023, which is incorporated herein by reference in its entirety.

### TECHNICAL FIELD

Embodiments of the present application relate to the field of communications, and to a wireless communication method and a device.

### RELATED ART

In order to improve quality of sidelink communication, it is necessary to support a bi-directional quality of service (QOS) requirement in the sidelink communication. How to support the bi-directional QoS requirement in the sidelink communication is a problem that needs to be solved.

### SUMMARY

The embodiments of the present application provide a wireless communication method and a device.

In a first aspect, a wireless communication method is provided, the method includes:
performing, by a receiving end, a first operation according to bi-directional quality of service (QOS) requirement information on a sidelink;
the first operation includes at least one of: determining a packet delay budget (PDB) of a reverse link, adjusting the PDB of the reverse link, determining a PDU set delay budget (PSDB) of the reverse link, adjusting the PSDB of the reverse link, determining a remaining delay, determining a remaining delay of the reverse link, deleting packets, recommending a PSDB of a forward link, recommending a PDB of the forward link, adjusting a selected resource, adjusting a selected resource set, selecting a transmission resource, selecting a transmission resource set, recommending an optional resource for a transmitting end, recommending an optional resource set for the transmitting end, triggering feedback, performing feedback, obtaining or determining time information, obtaining or determining delay information, or obtaining or determining auxiliary information.

In a second aspect, a wireless communication method is provided, the method includes:
performing, by a transmitting end, a second operation according to bi-directional QoS requirement information on a sidelink;
the second operation includes at least one of: transmitting delay information to a receiving end, transmitting time information to the receiving end, transmitting auxiliary information to the receiving end, modifying or determining a forward transmission delay, adjusting or determining a PSDB of a forward link, adjusting or determining a PDB of the forward link, determining the delay information, determining the time information, determining the auxiliary information, determining a remaining delay, deleting packets, determining a recommended PSDB of a reverse link, determining a recommended PDB of the reverse link, adjusting a selected resource set, selecting a transmission resource, selecting a transmission resource set, recommending an optional resource for the receiving end, or recommending an optional resource set for the receiving end.

In a third aspect, a receiving device is provided to perform the method in the above first aspect.

Optionally, the receiving end device includes a functional module to perform the method in the above first aspect.

In a fourth aspect, a transmitting device is provided to perform the method in the above second aspect.

Optionally, the transmitting end device includes a functional module to perform the method in the above second aspect.

In a fifth aspect, a receiving end device is provided, which includes a processor and a memory. The memory is configured to store a computer program, and the processor is configured to call the computer program stored in the memory and run the computer program, to enable the receiving end device to perform the method in the above first aspect.

In a sixth aspect, a transmitting end device is provided, which includes a processor and a memory. The memory is configured to store a computer program, and the processor is configured to call the computer program stored in the memory and run the computer program, to enable the transmitting end device to perform the method in the above second aspect.

In a seventh aspect, an apparatus is provided, which is configured to implement the method in any one of the above first to second aspects.

Optionally, the apparatus includes a processor, and the processor is configured to call a computer program from a memory and run the computer program, to enable a device equipped with the apparatus to perform the method in any one of the above first to second aspects.

In an eighth aspect, a non-transitory computer-readable storage medium is provided, which is configured to store a computer program. The computer program enables a computer to perform the method in any one of the above first to second aspects.

In a ninth aspect, a computer program product is provided, which includes computer program instructions. The computer program instructions enable a computer to perform the method in any one of the above first to second aspects.

In a tenth aspect, a computer program is provided, and the computer program, when executed on a computer, enables the computer to perform the method in any one of the above first to second aspects.

### BRIEF DESCRIPTION OF THE DRAWINGS

FIG. 1 is a schematic diagram of a communication system architecture provided by the present application.

FIG. 2 is a schematic diagram of another communication system architecture provided by the present application.

FIG. 3 is a schematic diagram of resource selection based on coordination between terminals provided by the present application.

FIG. 4 is a schematic flowchart of a wireless communication method according to the embodiments of the present application.

FIG. 5 is a schematic diagram of a receiving end and a transmitting end according to the embodiments of the present application.

FIG. 6 is a schematic flowchart of another wireless communication method according to the embodiments of the present application.

FIG. 7 is a schematic block diagram of a receiving end according to the embodiments of the present application.

FIG. 8 is a schematic block diagram of a transmitting end according to the embodiments of the present application.

FIG. 9 is a schematic block diagram of a communication device according to the embodiments of the present application.

FIG. 10 is a schematic block diagram of an apparatus according to the embodiments of the present application.

FIG. 11 is a schematic block diagram of a communication system according to the embodiments of the present application.

### DETAILED DESCRIPTION

Technical solutions in the embodiments of the present application will be described below in conjunction with drawings of the embodiments of the present application. Obviously, the described embodiments are some but not all of the embodiments of the present application. All other embodiments obtained by those ordinary skilled in the art based on the embodiments of the present application shall fall within the protection scope of the present application.

The technical solutions in the embodiments of the present application may be applied to various communication systems, such as a global system of mobile communication (GSM) system, a code division multiple access (CDMA) system, a wideband code division multiple access (WCDMA) system, a general packet radio service (GPRS), a long term evolution (LTE) system, an advanced long term evolution (LTE-A) system, a new radio (NR) system, an evolution system of the NR system, an LTE-based access to unlicensed spectrum (LTE-U) system, an NR-based access to unlicensed spectrum (NR-U) system, a non-terrestrial network (NTN) system, a universal mobile telecommunication system (UMTS), a wireless local area network (WLAN), wireless fidelity (WiFi), a 5th-generation (5G) communication system or other communication systems.

Generally speaking, traditional communication systems support a limited number of connections, which is also easy to be implemented. However, with the development of the communication technology, mobile communication systems will not only support traditional communications, but also support, for example, device to device (D2D) communication, machine to machine (M2M) communication, machine type communication (MTC), vehicle to vehicle (V2V) communication, or vehicle to everything (V2X) communication, etc. The embodiments of the present application may be applied to these communication systems as well.

The communication system in the embodiments of the present application may be applied to a carrier aggregation (CA) scenario, a dual connectivity (DC) scenario, and may also be applied to a standalone (SA) network deployment scenario.

In some embodiments, the communication system in the embodiments of the present application may be applied to an unlicensed spectrum, where the unlicensed spectrum may be considered as a shared spectrum. Alternatively, the communication system in the embodiments of the present application may be applied to a licensed spectrum, where the licensed spectrum may be considered as an unshared spectrum.

In some embodiments, the communication system in the embodiments of the present application may be applied to an FRI frequency band (corresponding to a frequency band in a range of 410 MHz to 7.125 GHZ), and may also be applied to an FR2 frequency band (corresponding to a frequency band in a range of 24.25 GHz to 52.6 GHZ), and may also be applied to a new frequency band such as an FRX (corresponding to a frequency band in a range of 52.6 GHz to 71 GHZ) or a high-frequency frequency band corresponding to a frequency band in a range of 71 GHz to 114.25 GHZ.

In the embodiments of the present application, various embodiments are described in conjunction with a transmitting end and a receiving end; the transmitting end may be a terminal device, and the receiving end may also be a terminal device. The terminal device may also be referred to as a user equipment (UE), an access terminal, a user unit, a user station, a mobile station, a mobile platform, a remote station, a remote terminal, a mobile device, a user terminal, a terminal, a wireless communication device, a user agent, a user device, or the like.

The terminal device may be a station (ST) in WLAN, which may be a cellular phone, a cordless phone, a session initiation protocol (SIP) phone, a wireless local loop (WLL) station, a personal digital assistant (PDA) device, a handheld device and a computing device with a wireless communication function, or other processing devices connected to a wireless modem, a vehicle-mounted device, a wearable device, a terminal device in a next-generation communication system (such as in an NR network), a terminal device in a future evolved public land mobile network (PLMN), or the like.

In the embodiments of the present application, the terminal device may be deployed on land including indoor or outdoor, in handheld, worn or vehicle-mounted, may also be deployed on water (e.g., on a ship), and may also be deployed in the air (e.g., on an airplane, a balloon, and a satellite).

In the embodiments of the present application, the terminal device may be a mobile phone, a pad, a computer with a wireless transceiving function, a virtual reality (VR) terminal device, an augmented reality (AR) terminal device, a wireless terminal device in industrial control, a wireless terminal device in self driving, a wireless terminal device in remote medical, a wireless terminal device in smart grid, a wireless terminal device in transportation safety, a wireless terminal device in smart city, a wireless terminal device in smart home, or the like.

As an example but not a limitation, in the embodiments of the present application, the terminal device may also be a wearable device. The wearable device, which is also referred to as a wearable smart device, is a generic term for a device that may be worn, into which the daily wear is intelligently designed and developed by applying wearable technologies, such as glasses, gloves, watches, clothing, and shoes. The wearable device is a portable device that is worn directly on the body, or integrated into the user's clothing or accessories. The wearable device is not just a hardware device, but also implements powerful functions through software supporting, data interaction, and cloud interaction. In a broad sense, wearable smart devices include those that are fully functional, large in size, and may implement complete or partial functions without relying on smartphones, such as smart watches or smart glasses, as well as those that only focus on a certain type of application function and need to be used in conjunction with other devices (e.g., smartphones), such as various smart bracelets and smart jewelry for physical sign monitoring.

In the embodiments of the application, the network device may be a device used for communicating with a mobile device. The network device may be an access point (AP) in the WLAN, a base station (BTS) in the GSM or CDMA. The network device may also be a base station (NB) in the WCDMA, and may further be an evolutional base station (evolutional Node B, eNB or eNodeB) in the LTE, a relay station or an access point, a vehicle-mounted device, a wearable device, a network device or a base station (gNB) in an NR network, a network device in the future evolved PLMN, a network device in the NTN, or the like.

As an example but not a limitation, in the embodiments of the present application, the network device may have a mobile characteristic; for example, the network device may be a mobile device. Optionally, the network device may be a satellite or a balloon station. For example, the satellite may be a low earth orbit (LEO) satellite, a medium earth orbit (MEO) satellite, a geostationary earth orbit (GEO) satellite, a high elliptical orbit (HEO) satellite, or the like. Optionally, the network device may also be a base station located on land, water, and other places.

In the embodiments of the present application, the network device may provide a service for a cell, and the terminal device communicates with the network device through a transmission resource (e.g., a frequency domain resource, or a frequency spectrum resource) used by the cell. The cell may be a cell corresponding to the network device (e.g., the base station), the cell may belong to a macro base station, or may also belong to a base station corresponding to a small cell, and the small cell here may include: a metro cell, a micro cell, a pico cell, a femto cell, and the like, these small cells have characteristics of small coverage range and low transmission power, which are applicable for providing a data transmission service with high speed.

It will be understood that the terms “system” and “network” are often used interchangeably herein. Herein, the term “and/or” is only an association relationship to describe associated objects, which means that there may be three kinds of relationships. For example, A and/or B may represent three cases that: A exists alone, both A and B exist, and B exists alone. In addition, a character “/” herein generally means that related objects before and after “/” are in an “or” relationship.

The terms used in the implementation section of the present application are only used to explain embodiments of the present application, and are not intended to limit the present application. The terms “first”, “second”, “third”, “fourth”, “A-th”, “B-th” and the like in the specification, claims and drawings of the present application are used to distinguish different objects rather than to describe a specific order. In addition, the terms “include” and “have” and any variations thereof are intended to cover a non-exclusive inclusion.

It should be understood that “indicate” mentioned in the embodiments of the present application may mean a direct indication, an indirect indication, or may represent that there is an association relationship. For example, A indicates B, which may mean that A directly indicates B, for example, B may be acquired by A; or may mean that A indirectly indicates B, for example, A indicates C, and B may be acquired by C; or may mean that there is an association relationship between A and B.

It should be understood that the “at least one” mentioned in the embodiments of the present application may mean “one or more”, and the “positive integer” mentioned in the embodiments of the present application may mean “1, 2, 3 . . . and other values”, and the “non-negative integer” mentioned in the embodiments of the present application may mean “0, 1, 2, 3 . . . and other values”, and the “integer” mentioned in the embodiments of the present application may mean “ . . . , −3, −2, −1, 0, 1, 2, 3, . . . and other values”, which may be replaced with any possible value based on the requirements of the embodiment.

It should be understood that the figures and/or tables shown in the embodiments of the present application are only examples. Optionally, in some cases, some of the information contained in the figures and/or tables shown in the embodiments of the present application may independently constitute an optional embodiment. For example, each row or each column in the table may independently constitute an optional embodiment, which is not limited in the present application.

In the description of the embodiments of the present application, the term “corresponding” may indicate that there is a direct or indirect correspondence between two items, or that there is an associated relationship between the two items, or that there is a relationship of indicating and being indicated, configuring and being configured, etc.

In the embodiments of the present application, “predefined” or “preconfigured” may be implemented by pre-saving corresponding codes, tables or other manners that may be used for indicating related information, in a device (e.g., including a terminal device and a network device), but the specific implementation is not limited in the present application. For example, “predefined” may refer to those defined in a protocol.

In the embodiments of the present application, the “protocol” may refer to a standard protocol in the communication field; for example, it may include an LTE protocol, an NR protocol, and related protocols used in future communication systems, which is not limited in the present application.

In order to facilitate understanding of the technical solutions of the embodiments of the present application, the technical solutions of the present application are described in detail below through some embodiments. The following related technologies may be arbitrarily combined with the technical solutions of the embodiments of the present application as optional solutions, which all fall within the protection scope of the embodiments of the present application. The embodiments of the present application include at least part of the following contents.

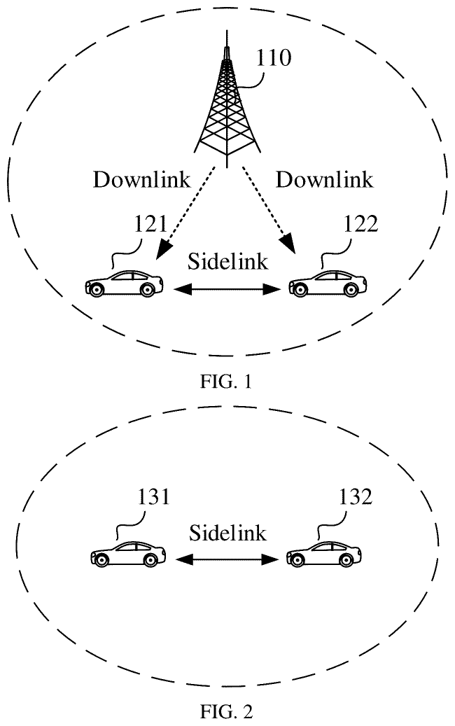

FIG. 1 is a schematic diagram of a communication system applicable to the embodiments of the present application. Transmission resources of the vehicle-mounted terminals (a vehicle-mounted terminal 121 and a vehicle-mounted terminal 122) are allocated by a base station 110, and the vehicle-mounted terminals transmit data on the sidelink according to the resources allocated by the base station 110. Optionally, the base station 110 may allocate resources for single transmission to the terminal, or may allocate resources for semi-static transmission to the terminal.

FIG. 2 is a schematic diagram of another communication system applicable to the embodiments of the present application. The vehicle-mounted terminals (a vehicle-mounted terminal 131 and a vehicle-mounted terminal 132) autonomously select transmission resources on the sidelink resources for data transmission. Optionally, the vehicle-mounted terminal may select a transmission resource randomly, or select a transmission resource by listening.

It should be noted that device-to-device communication is a sidelink (SL) transmission technology based on D2D, which is different from the way in which communication data is received or transmitted by base stations in conventional cellular systems. Therefore, it has higher spectrum efficiency and lower transmission latency. The Internet of Vehicles system adopts terminal-to-terminal direct communication. The 3GPP defines two transmission modes, which are respectively referred to as a first mode (sidelink resource allocation mode 1) and a second mode (sidelink resource allocation mode 2).

The first mode: the transmission resources of the terminal are allocated by the base station, and the terminal transmits data on the sidelink according to the resources allocated by the base station; the base station may allocate resources for a single transmission to the terminal, and may also allocate resources for semi-static transmission to the terminal. The terminal is within a coverage of the network, and the network allocates transmission resources for sidelink transmission to the terminal.

The second mode: the terminal selects a resource in a resource pool to transmit data. The terminal is located outside a coverage of a cell, and the terminal autonomously selects transmission resources from a pre-configured resource pool for sidelink transmission; or, the terminal autonomously selects transmission resources from a resource pool configured by the network for sidelink transmission.

In the new radio-vehicle to everything (NR-V2X), autonomous driving is supported, which puts forward higher requirements for data interaction between vehicles, such as higher throughput, lower latency, higher reliability, larger coverage, and more flexible resource allocation. In NR-V2X, unicast, multicast and broadcast transmission modes are supported.

For the second mode, the terminal selects resources in the resource pool that are not reserved by other terminals or are reserved by other terminals but have lower receiving power by decoding sidelink control information and measuring sidelink receiving power, thereby reducing the probability of resource collision and improving communication reliability. The second mode generally inherits the main design of the resource selection mechanism in LTE-V2X mode 4, and performs resource selection based on operations such as resource reservation, resource listening, and resource exclusion.

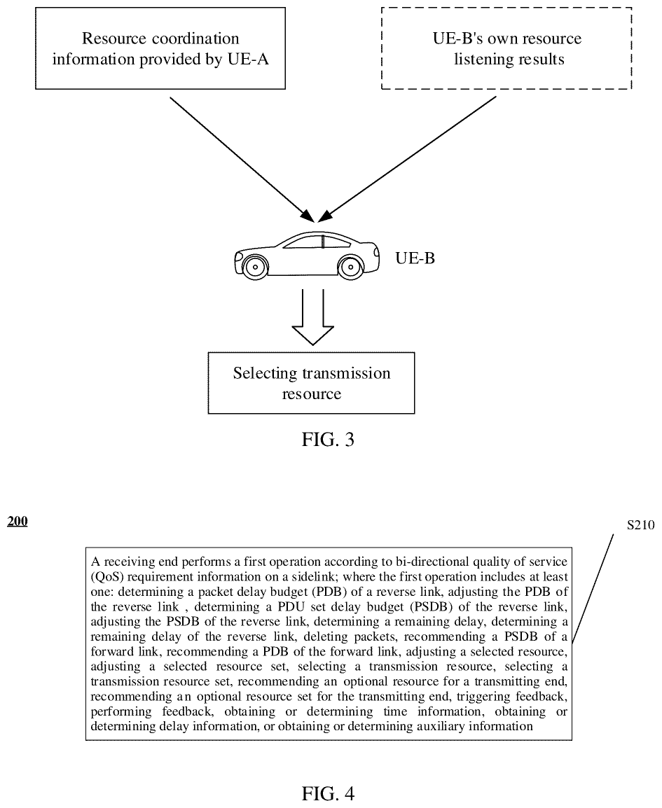

For the resource selection scheme coordinated between UEs, a terminal (UE-A) provides resource coordination information to another terminal (UE-B) that performs resource selection in the second mode. The UE-B will select the final transmission resource based on its own resource listening results and the received resource coordination information, or select the transmission resource only based on the resource coordination information, as shown in FIG. 3. For example, the transmitting end selects the final transmission resource based on the quality of service (QOS) information (e.g., a priority of a logical channel (LCH), a packet delay budget (PDB)) and a resource transmission set recommended by the receiving end, and performs sidelink (SL) transmission between terminals (UE-UE), or performs transmission between terminal-relay (UE-relay), or performs transmission between terminal-relay-terminal (UE-Relay-UE), or performs transmission between relays (Relay-relay).

In order to facilitate a better understanding of the embodiments of the present application, the problems solved by the present application are explained.

5G needs to support real-time QoS parameters, including round trip time (RTT). The RTT is a transmission delay between two ends. How to support the bi-directional QoS requirement, i.e., a RTT requirement, on SL is a problem that needs to be solved.

Based on the above problems, the present application proposes a sidelink communication solution. In the case of having a bi-directional QoS requirement, a transmitting end and/or a receiving end may perform related operations according to bi-directional QoS requirement information, thereby improving the quality of sidelink communication.

In order to facilitate understanding of the technical solutions of the embodiments of the present application, the technical solutions of the present application will be described in detail below through some embodiments. The following related arts may be arbitrarily combined with the technical solutions of the embodiments of the present application as optional solutions, which all belong to the protection scope of the embodiments of the present application. The embodiments of the present application include at least part of the following contents.

FIG. 4 is a schematic flowchart of a wireless communication method 200 according to the embodiments of the present application. As shown in FIG. 4, the wireless communication method 200 may include at least part of the following contents.

In S210, a receiving end performs a first operation according to bi-directional QoS requirement information on a sidelink; the first operation includes at least one of: determining PDB of a reverse link, adjusting the PDB of the reverse link, determining a PDU set delay budget (PSDB) of the reverse link, adjusting the PSDB of the reverse link, determining a remaining delay, determining a remaining delay of the reverse link, deleting packets, recommending a PSDB of a forward link, recommending a PDB of the forward link, adjusting a selected resource, adjusting a selected resource set, selecting a transmission resource, selecting a transmission resource set, recommending an optional resource for a transmitting end, recommending an optional resource set for the transmitting end, triggering feedback, performing feedback, obtaining or determining time information, obtaining or determining delay information, or obtaining or determining auxiliary information.

It should be understood that FIG. 4 shows steps or operations of the wireless communication method 200, but these steps or operations are merely examples, and in the embodiments of the present application, other operations or variations of the operations in FIG. 4 may also be performed.

In the embodiments of the present application, in the case of having a bi-directional QoS requirement, the receiving end may perform the first operation according to the bi-directional QoS requirement information, thereby ensuring the bi-directional QoS requirement to improve the quality of sidelink communication.

In the embodiments of the present application, the receiving end may also be referred to as a receiving end device, and the transmitting end may also be referred to as a transmitting end device. Optionally, the receiving end may be a terminal device, a receiving terminal, or a relay, and the transmitting end may be a terminal device, a transmitting terminal, or a relay. Optionally, the receiving end and the transmitting end communicate directly via the sidelink, or the receiving end and the transmitting end communicate via a relay link.

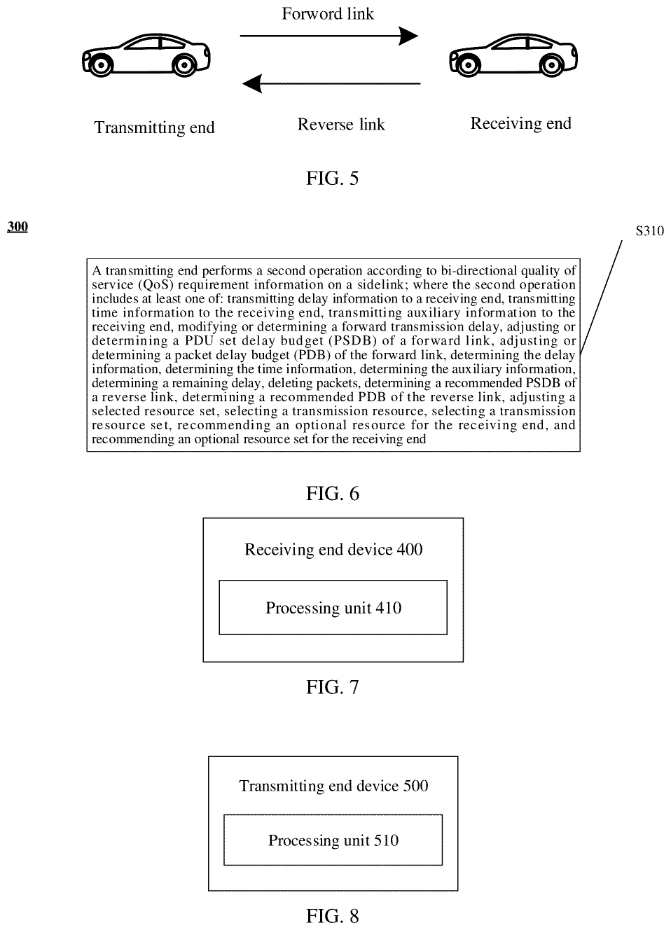

In the embodiments of the present application, a link from the transmitting end to the receiving end is a forward link, and a link from the receiving end to the transmitting end is a reverse link, as shown in FIG. 5.

In the embodiments of the present application, a peer end or multiple parties for the bi-directional QoS requirement may be explicitly indicated (for example, two parties pre-configured by an application layer or a network, or a group pre-configured by the application layer or the network, or a peer end or multiple parties involved in the interaction between the transmitting end and the receiving end or configured to perform the first operation), or may be implicitly determined (for example, whether configured QoS parameters include bi-directional QoS parameters, or whether bi-directional QoS is enabled, or the peer end or multiple parties that transmit and/or receive the bi-directional QoS requirement, the peer end or multiple parties that perform the first operation).

In some embodiments, the bi-directional QoS requirement information is dynamic or semi-static.

For example, the first operation includes determining/adjusting a PDB of the reverse link. Thus, in a case of having the bi-directional QoS requirement, the receiving end may determine/adjust the PDB of the reverse link according to the bi-directional QoS requirement information.

For example, the first operation includes determining/adjusting a PSDB of the reverse link. Thus, in a case of having the bi-directional QOS requirement, the receiving end may determine/adjust the PSDB of the reverse link according to the bi-directional QoS requirement information.

For example, the first operation includes determining/adjusting a PDB of the reverse link, and determining/adjusting the PSDB of the reverse link. Thus, in the case of having the bi-directional QOS requirement, the receiving end may determine/adjust the PDB of the reverse link and determine/adjust the PSDB of the reverse link according to the bi-directional QoS requirement information.

For example, the first operation includes determining/adjusting a PDB of the reverse link and determining the remaining delay. Thus, in a case of having the bi-directional QoS requirement, the receiving end may determine/adjust the PDB of the reverse link and determine the remaining delay according to the bi-directional QoS requirement information, so that the receiving end may perform more reasonable transmission on the reverse link.

For example, the first operation includes determining/adjusting a PDB of the reverse link, adjusting the selected resource and/or resource set. Thus, in a case of having the bi-directional QoS requirement, the receiving end may determine/adjust the PDB of the reverse link and adjust the selected resource and/or resource set according to the bi-directional QoS requirement information, so that the receiving end may perform more reasonable transmission on the reverse link.

For example, the first operation includes determining/adjusting a PDB of the reverse link, selecting the transmission resource and/or resource set. Thus, in a case of having the bi-directional QoS requirement, the receiving end may determine/adjust the PDB of the reverse link and select the transmission resource and/or resource set according to the bi-directional QoS requirement information, so that the receiving end may perform more reasonable transmission on the reverse link.

For example, the first operation includes recommending an optional resource and/or resource set for the transmitting end. Thus, in a case of having the bi-directional QoS requirement, the receiving end may recommend the optional resources and/or resource sets of the transmitting end according to the bi-directional QoS requirement information, so that the transmitting end may perform more reasonable transmission on the forward link.

For example, the first operation includes recommending an optional resource and/or resource set for the transmitting end and performing feedback. Thus, in a case of having the bi-directional QoS requirement, the receiving end may recommend the optional resources and/or resource sets of the transmitting end and perform feedback according to the bi-directional QoS requirement information, so that the transmitting end may perform more reasonable transmission on the forward link.

For example, the first operation includes determining/adjusting a PDB of the reverse link, determining the remaining delay or determining the remaining delay of the reverse link. Thus, in a case of having the bi-directional QoS requirement, the receiving end may determine/adjust the PDB of the reverse link, and determine the remaining delay or determine the remaining delay of the reverse link according to the bi-directional QoS requirement information, so that the receiving end may perform more reasonable transmission on the reverse link.

For example, the first operation includes determining/adjusting a PDB of the reverse link and deleting packets. Thus, in a case of having the bi-directional QoS requirement, the receiving end may determine/adjust the PDB of the reverse link and delete packet according to the bi-directional QoS requirement information, so that the receiving end may perform more reasonable transmission on the reverse link.

For example, the first operation includes determining/adjusting a PDB of the reverse link, determining the remaining delay or determining the remaining delay of the reverse link, and adjusting the selected resource and/or resource set. Thus, in a case of having the bi-directional QoS requirement, the receiving end may determine/adjust the PDB of the reverse link, determine the remaining delay or determine the remaining delay of the reverse link, and adjust the selected resource and/or resource set according to the bi-directional QoS requirement information, so that the receiving end may perform more reasonable transmission on the reverse link.

For example, the first operation includes determining/adjusting a PDB of the reverse link, determining the remaining delay or determining the remaining delay of the reverse link, adjusting the selected resource and/or resource set, and deleting packets. Thus, in a case of having the bi-directional QoS requirement, the receiving end may determine/adjust the PDB of the reverse link, determine the remaining delay or determine the remaining delay of the reverse link, adjust the selected resource and/or resource set, and delete packets according to the bi-directional QoS requirement information, so that the receiving end may perform more reasonable transmission on the reverse link.

In some embodiments, in a case where the first operation includes adjusting a PDB of the reverse link, the receiving end may adjust the PDB of the reverse link based on preset PDB parameters, or the receiving end may adjust the PDB of the reverse link based on PDB parameters determined by negotiation between the receiving end and the transmitting end, or the receiving end may autonomously decide how to adjust the PDB of the reverse link.

In some embodiments, in a case where the first operation includes adjusting a PSDB of the reverse link, the receiving end may adjust the PSDB of the reverse link based on preset PSDB parameters, or the receiving end may adjust the PSDB of the reverse link based on PSDB parameters determined by negotiation between the receiving end and the transmitting end, or the receiving end may autonomously decide how to adjust the PSDB of the reverse link.

In some embodiments, in a case where the first operation includes recommending a PSDB of the forward link, the receiving end may recommend the PSDB of the forward link based on preset PSDB parameters, or the receiving end may recommend the PSDB of the forward link based on PSDB parameters determined by negotiation between the receiving end and the transmitting end, or the receiving end may autonomously decide how to recommend the PSDB of the forward link.

In some embodiments, in a case where the first operation includes recommending a PDB of the forward link, the receiving end may recommend the PDB of the forward link based on preset PDB parameters, or the receiving end may recommend the PDB of the forward link based on the PDB parameters determined by negotiation between the receiving end and the transmitting end, or the receiving end may autonomously decide how to recommend the PDB of the forward link.

In some embodiments, both the PSDB of the reverse link and the PDB of the reverse link may be determined/adjusted, or only the PSDB of the reverse link may be determined/adjusted, or only the PDB of the reverse link may be determined/adjusted.

In some embodiments, if a PSDB exists, or an indication is given to determine the PSDB, only the PSDB of the reverse link is determined/adjusted, or the PSDB of the reverse link is determined/adjusted, or the PDB of the reverse link is not determined/adjusted.

In some embodiments, if a PDB exists, or an indication is given to determine the PDB, only the PDB of the reverse link is determined/adjusted, or the PDB of the reverse link is determined/adjusted, or the PSDB of the reverse link is not determined/adjusted.

In some embodiments, if PSDB does not exists, or an indication is given not to determine the PSDB, only the PDB of the reverse link is determined/adjusted, or the PDB of the reverse link is determined/adjusted, or the PSDB of the reverse link is not determined/adjusted.

In some embodiments, in a case where the first operation includes deleting packets, the receiving end may delete the data packet or data to be transmitted or buffered. The data or data packet to be transmitted or buffered may be data or data packet transmitted using the reverse link, or data or data packet transmitted to a higher layer (e.g., a non-access stratum (NAS), an application layer).

In some embodiments, in a case where the first operation includes deleting packets, the receiving end may request the transmitting end or the peer end to transmit packet deletion auxiliary information. The packet deletion auxiliary information is used by the receiving end to perform a packet deletion operation. The auxiliary information includes but is not limited to sequence numbers.

In some embodiments, in a case where the first operation includes deleting packets, the receiving end may transmit packet deletion information to the transmitting end or the peer end. The packet deletion information is used to indicate the packet information deleted by the receiving end. The packet deletion information includes but is not limited to sequence numbers.

In some embodiments, in a case where the first operation includes determining a remaining delay, the receiving end may determine the remaining delay of the reverse link and/or the forward link.

For example, the first operation includes determining a remaining delay. Thus, in a case of having the bi-directional QoS requirement, the receiving end may determine/adjust the PDB of the reverse link and/or forward link according to the bi-directional QOS requirement information, so that the receiving end may perform more reasonable transmission on the reverse link, and/or the transmitting end may perform more reasonable transmission on the forward link.

For example, the first operation includes determining a remaining delay. Thus, in a case of having the bi-directional QoS requirement, the receiving end may determine/adjust the PSDB of the reverse link and/or forward link according to the bi-directional QoS requirement information, so that the receiving end may perform more reasonable transmission on the reverse link, and/or the transmitting end may perform more reasonable transmission on the forward link.

For example, the first operation includes determining a remaining delay. Thus, in a case of having the bi-directional QoS requirement, the receiving end may adjust the selected resource and/or resource set according to the bi-directional QoS requirement information, so that the receiving end may perform more reasonable transmission on the reverse link, and/or the transmitting end may perform more reasonable transmission on the forward link.

For example, the first operation includes determining a remaining delay. Thus, in a case of having the bi-directional QoS requirement, the receiving end may select the transmission resource and/or the resource set according to the bi-directional QoS requirement information, so that the receiving end may perform more reasonable transmission on the reverse link, and/or the transmitting end may perform more reasonable transmission on the forward link.

For example, the first operation includes determining a remaining delay. Thus, in a case of having the bi-directional QoS requirement, the receiving end may delete packets according to the bi-directional QoS requirement information, so that the receiving end may perform more reasonable transmission on the reverse link, and/or the transmitting end may perform more reasonable transmission on the forward link.

For example, the first operation includes determining a remaining delay. Thus, in a case of having the bi-directional QoS requirement, the receiving end may perform feedback according to the bi-directional QoS requirement information, so that the receiving end may perform more reasonable transmission on the reverse link, and/or the transmitting end may perform more reasonable transmission on the forward link.

For example, the first operation includes determining or obtaining time information, and/or determining or obtaining delay information, and/or determining or obtaining auxiliary information. Optionally, the time information and/or the delay information and/or the auxiliary information may be obtained by the receiving end from the transmitting end, or may be determined by the receiving end according to information from the transmitting end, or may be determined by the receiving end according to information from the network, or may be evaluated by the receiving end itself.

For example, the first operation includes determining or obtaining time information, and/or determining or obtaining delay information, and/or determining or obtaining auxiliary information. Thus, in a case of having the bi-directional QoS requirement, the receiving end may determine/adjust the PDB of the reverse link and/or forward link according to the bi-directional QoS requirement information, so that the receiving end may perform more reasonable transmission on the reverse link, and/or the transmitting end may perform more reasonable transmission on the forward link.

For example, the first operation includes determining or obtaining time information, and/or determining or obtaining delay information, and/or determining or obtaining the auxiliary information. Thus, in a case of having the bi-directional QoS requirement, the receiving end may determine/adjust the PSDB of the reverse link and/or forward link according to the bi-directional QoS requirement information, so that the receiving end may perform more reasonable transmission on the reverse link, and/or the transmitting end may perform more reasonable transmission on the forward link.

For example, the first operation includes determining or obtaining time information, and/or determining or obtaining delay information, and/or determining or obtaining auxiliary information. Thus, in a case of having the bi-directional QoS requirement, the receiving end may adjust the selected resource and/or resource set according to the bi-directional QoS requirement information, so that the receiving end may perform more reasonable transmission on the reverse link, and/or the transmitting end may perform more reasonable transmission on the forward link.

For example, the first operation includes determining or obtaining time information, and/or determining or obtaining delay information, and/or determining or obtaining auxiliary information. Thus, in a case of having the bi-directional QoS requirement, the receiving end may select the transmission resource and/or resource set according to the bi-directional QoS requirement information, so that the receiving end may perform more reasonable transmission on the reverse link, and/or the transmitting end may perform more reasonable transmission on the forward link.

For example, the first operation includes determining or obtaining time information, and/or determining or obtaining delay information, and/or determining or obtaining auxiliary information. Thus, in a case of having the bi-directional QoS requirement, the receiving end may delete packets according to the bi-directional QoS requirement information, so that the receiving end may perform more reasonable transmission on the reverse link, and/or the transmitting end may perform more reasonable transmission on the forward link.

For example, the first operation includes determining or obtaining time information, and/or determining or obtaining delay information, and/or determining or obtaining auxiliary information. Thus, in a case of having the bi-directional QoS requirement, the receiving end may perform feedback according to the bi-directional QoS requirement information, so that the receiving end may perform more reasonable transmission on the reverse link, and/or the transmitting end may perform more reasonable transmission on the forward link.

For example, the first operation includes determining or obtaining time information, and/or determining or obtaining delay information, and/or determining or obtaining auxiliary information. Thus, in a case of having the bi-directional QoS requirement, the receiving end may determine the remaining delay according to the bi-directional QoS requirement information, so that the receiving end may perform more reasonable transmission on the reverse link, and/or the transmitting end may perform more reasonable transmission on the forward link.

In some embodiments, in a case where the first operation includes adjusting a selected resource, adjusting the selected resource includes but is not limited to at least one of: determining a resource for transmission, determining an available resource in a candidate resource set, determining a priority of the resource in the candidate resource set, or adjusting a priority of the available resource in selection. Optionally, the selected resource is a resource transmitted from the receiving end to the transmitting end.

In some embodiments, in a case where the first operation includes adjusting a selected resource set, adjusting the selected resource set includes but is not limited to at least one of: determining a resource set for transmission, determining an available resource set in the candidate resource set, or adjusting a priority of the available resource set in selection. Optionally, the resource set selected for adjustment is a resource set transmitted from the receiving end to the transmitting end.

In some embodiments, in a case where the first operation includes selecting the transmission resource, selecting the transmission resource includes but is not limited to at least one of: selecting a transmission resource from candidate resources, or selecting a transmission resource from the candidate resource set. Optionally, the selected transmission resource is a resource transmitted from the receiving end to the transmitting end.

In some embodiments, in a case where the first operation includes selecting the transmission resource set, selecting the transmission resource set includes: selecting a transmission resource set from the candidate resource set. Optionally, the selected transmission resource set is a resource set transmitted from the receiving end to the transmitting end.

In some embodiments, recommending the optional resource for the transmitting end includes, but is not limited to, at least one of: recommending the optional resource for data transmitted from the transmitting end to the receiving end, recommending the optional resource for a data packet transmitted from the transmitting end to the receiving end, recommending the optional resource for information transmitted from the transmitting end to the receiving end, or recommending the transmission resource for the data packet or information transmitted from the transmitting end to the receiving end.

In some embodiments, recommending the optional resource set for the transmitting end includes but is not limited to at least one of: recommending the optional resource set for data transmitted from the transmitting end to the receiving end, recommending the optional resource set for data packets transmitted from the transmitting end to the receiving end, recommending the optional resource set for information transmitted from transmitting end to the receiving end, or recommending the transmission resource set for the data packet or information transmitted from the transmitting end to the receiving end.

In some embodiments, triggering feedback includes but is not limited to at least one of: triggering the transmitting end transmitting auxiliary information, or triggering the transmitting end transmitting time information and/or delay information. Optionally, the auxiliary information may be auxiliary information used for assisting in performing the first operation.

In some embodiments, performing feedback includes but is not limited to at least one of: transmitting feedback information to the transmitting end; triggering the receiving end transmitting the feedback information to the transmitting end; feeding back time information and/or delay information of the reverse link; feeding back resource information selected by the receiving end; transmitting or feeding back, to the transmitting end, the resource or information recommended by the receiving end for use by the transmitting end; transmitting, to the transmitting end, the information requested by the receiving end for the transmitting end to transmit or trigger; feeding back, to the transmitting end, the information requested by the receiving end for the transmitting end to transmit or trigger; transmitting or feeding back, to a peer end, the resource or information recommended by the receiving end for use by the transmitting end; transmitting, to the peer end, information requested by the receiving end for the transmitting end to transmit or trigger; or feeding back, to the peer end, the information requested by the receiving end for the transmitting end to transmit or trigger.

In some embodiments, in a case where the first operation includes at least performing feedback or triggering feedback, the first operation is used for the transmitting end to perform at least one of:
determining a PDB of the forward link, adjusting the PDB of the forward link, determining a PSDB of the forward link, adjusting the PSDB of the forward link, determining an unidirectional transmission delay (e.g., a transmission delay of the reverse link or a transmission delay of the forward link), adjusting a selected resource (for example, adjusting a selected resource for transmission from the transmitting end to the receiving end), adjusting a selected resource set (for example, adjusting a selected resource set for transmission from the transmitting end to the receiving end), selecting a transmission resource (for example, selecting a resource for transmission from the transmitting end to the receiving end), selecting a transmission resource set (for example, selecting a resource set for transmission from the transmitting end to the receiving end), recommending the optional resource set (e.g., a resource set transmitted from the receiving end to the transmitting end) for the receiving end, recommending the optional resource (e.g., a resource transmitted from the receiving end to the transmitting end) for the receiving end, transmitting auxiliary information (e.g., auxiliary information used for assisting in performing the first operation), transmitting time information and/or delay information, or deleting packets (for example, the transmitting end may delete a data packet or data to be transmitted or buffered, where the data or data packet to be transmitted or buffered; optionally, the data or data packet to be transmitted or buffered may be data or data packet transmitted using the forward link, or may be data or data packet transmitted to a higher layer (e.g. a NAS, an application layer)).

For example, the first operation is used by the transmitting end to determine or adjust the PDB of the forward link, so that the forward link transmission may be optimized.

For example, the first operation is used by the transmitting end to determine or adjust the PDB of the forward link, and determine or adjust the PSDB of the forward link, so that the forward link transmission may be optimized.

For example, the first operation is used by the transmitting end to determine or adjust the PDB of the forward link, and determine the unidirectional transmission delay, so that the forward link transmission may be optimized.

For example, the first operation is used by the transmitting end to determine or adjust the PDB of the forward link, and adjust the selected resource and/or resource set, so that the forward link transmission may be optimized.

For example, the first operation is used by the transmitting end to determine or adjust the PDB of the forward link, and select a transmission resource and/or resource set, so that the forward link transmission may be optimized.

For example, the first operation is used by the transmitting end to determine or adjust the PDB of the forward link and delete packets, so that the forward link transmission may be optimized.

For example, the first operation is used by the transmitting end to determine or adjust the PDB of the forward link, determine the unidirectional transmission delay, and delete packets, so that the forward link transmission may be optimized.

For example, the first operation is used by the transmitting end to determine or adjust the PDB of the forward link, adjust the selected resource and/or resource set, and delete packets, so that the forward link transmission may be optimized.

For example, the first operation is used by the transmitting end to determine or adjust the PDB of the forward link, determine the unidirectional transmission delay, select transmission resource and/or resource set, and delete packets, so that the forward link transmission may be optimized.

For example, the first operation is used by the transmitting end to determine or adjust the PDB of the forward link, select transmission resource and/or resource set, and delete packets, so that the forward link transmission may be optimized.

For example, the first operation is used by the transmitting end to determine or adjust the PDB of the forward link, determine the unidirectional transmission delay, adjust the selected resources and/or resource set, and delete packets, so that the forward link transmission may be optimized.

For example, the first operation is used by the transmitting end to determine or adjust the unidirectional transmission delay of the forward link, so that the forward link transmission may be optimized.

For example, the first operation is used by the transmitting end to determine or adjust the unidirectional transmission delay of the forward link, and adjust the selected resource and/or resource set, so that the forward link transmission may be optimized.

For example, the first operation is used by the transmitting end to determine or adjust the unidirectional transmission delay of the forward link, select a transmission resource and/or resource set, so that the forward link transmission may be optimized.

For example, the first operation is used by the transmitting end to determine or adjust a unidirectional transmission delay of the forward link and delete packets, so that the forward link transmission may be optimized.

For example, the first operation is used by the transmitting end to determine or adjust a unidirectional transmission delay of the forward link, adjust a selected resource and/or resource set, and delete packets, so that the forward link transmission may be optimized.

For example, the first operation is used by the transmitting end to determine or adjust a unidirectional transmission delay of the forward link, select a transmission resource and/or resource set, and delete packets, so that the forward link transmission may be optimized.

For example, the first operation is used by the transmitting end to recommend optional resources and/or resource sets of the receiving end, so that the reverse link transmission may be optimized.

For example, the first operation is used by the transmitting end to recommend optional resources and/or resource sets of the receiving end, and transmit auxiliary information, so that the reverse link transmission may be optimized.

For example, the first operation is used by the transmitting end to recommend optional resources and/or resource sets of the receiving end, and transmit time information and/or delay information, so that the reverse link transmission may be optimized.

For example, the first operation is used by the transmitting end to transmit time information and/or delay information, so that the reverse link transmission may be optimized.

For example, the first operation is used by the transmitting end to transmit auxiliary information, so that the reverse link transmission may be optimized.

For example, the first operation is used for the transmitting end to transmit time information and/or delay information, so that the receiving end may perform reverse link transmission based on the time information and/or delay information, or perform the first operation corresponding to the receiving end.

For example, the first operation is used for the transmitting end to transmit auxiliary information, so that the receiving end may perform reverse link transmission based on the auxiliary information, or perform the first operation corresponding to the receiving end.

For example, the first operation is used by the transmitting end to transmit auxiliary information, and transmit time information and delay information, so that the reverse link transmission may be optimized.

For example, the first operation is used by the transmitting end to recommend optional resources and/or resource sets of the receiving end, transmit auxiliary information, and transmit time information and/or delay information, so that the reverse link transmission may be optimized.

In some embodiments, the bi-directional QoS requirement information includes but is not limited to at least one of: RTT, or indication information for enabling or disabling the bi-directional QoS requirement. For example, the indication information for enabling or disabling the bi-directional QoS requirement may occupy one bit; a value of 0 indicates enabling the bi-directional QoS requirement, and a value of 1 indicates disabling the bi-directional QoS requirement; alternatively, a value of 1 indicates enabling the bi-directional QoS requirement, and a value of 0 indicates disabling the bi-directional QoS requirement.

In some embodiments, S210 may include that:
the receiving end performs the first operation according to the bi-directional QoS requirement information, and/or at least one of auxiliary information, delay information or time information obtained from the peer end or the transmitting end for assisting in performing the first operation.

For an example, the receiving end performs the first operation according to the bi-directional QoS requirement information and at least one of the auxiliary information, the delay information or the time information obtained from the peer end or the transmitting end for assisting in performing the first operation.

For an example, the receiving end performs the first operation according to the bi-directional QoS requirement information and/or the auxiliary information obtained from the peer end or the transmitting end for assisting in performing the first operation.

For another example, the receiving end performs the first operation according to the bi-directional QoS requirement information and/or the delay information obtained from the peer end or the transmitting end.

For another example, the receiving end performs the first operation according to the bi-directional QoS requirement information and/or the time information obtained from the peer end or the transmitting end.

For another example, the receiving end performs the first operation according to the bi-directional QoS requirement information and/or the auxiliary information and delay information obtained from the peer end or the transmitting end for assisting in performing the first operation.

For another example, the receiving end performs the first operation according to the bi-directional QoS requirement information and/or the auxiliary information and time information obtained from the peer end or the transmitting end for assisting in performing the first operation.

For another example, the receiving end performs the first operation according to the bi-directional QoS requirement information and/or the delay information and time information obtained from the peer end or the transmitting end.

For another example, the receiving end performs the first operation according to the bi-directional QoS requirement information and/or the auxiliary information, the delay information and the time information obtained from the peer end or the transmitting end for assisting in performing the first operation.

In some embodiments, the delay information includes but is not limited to at least one of: a bi-directional transmission delay, a bi-directional PDB, a PDB of the reverse link recommended by the transmitting end, a bi-directional PSDB, a PSDB of the reverse link recommended by the transmitting end, a remaining delay determined by the transmitting end, or a delay used/occupied by the transmitting end.

Optionally, the bi-directional PDB may be a PDB of the forward link and a PDB of the reverse link, or a round-trip delay/delay budget between two ends.

Optionally, the bi-directional PSDB may be a PSDB of the forward link and a PSDB of the reverse link, or a round-trip delay/delay budget between two ends.

For an example, the remaining delay determined by the transmitting end may be a remaining delay of the forward link and/or a remaining delay of the reverse link.

In some embodiments, the delay information corresponds to a real-time delay, or the delay information corresponds to a statistical delay within a first duration, or the delay information is a delay corresponding to a first time, or the delay information is a delay corresponding to a first event and/or a first condition.

In some embodiments, the first duration is agreed by the protocol, or the first duration is configured (semi-statically configured or dynamically configured) by the network, or the first duration is determined by negotiation between the receiving end and the transmitting end.

In some embodiments, the first time is an absolute time, or the first time is a relative time, or the first time is associated with a first system frame number (SFN), or the first time is associated with a first slot, or the first time is associated with a first time domain symbol, or the first time is associated with a first reference time.

Optionally, the first SFN is agreed by the protocol, or the first SFN is configured (semi-statically configured or dynamically configured) by the network, or the first SFN is determined by one of the transmitting end or the receiving end, or the first SFN is determined by negotiation between the receiving end and the transmitting end.

For an example, the first time is associated with the first SFN, which may be: the first time being a starting time point of the first SFN, or the first time being an ending time point of the first SFN, or the first time being an upper boundary of the first SFN, or the first time being a lower boundary of the first SFN, or the first time being a first symbol at the end of the first SFN.

Optionally, the first slot is agreed by the protocol, or the first slot is configured (semi-statically configured or dynamically configured) by the network, or the first slot is determined by one of the transmitting end or the receiving end, or the first slot is determined by negotiation between the receiving end and the transmitting end.

For an example, the first time is associated with the first slot, which may be: the first time being a starting time point of the first slot, or the first time being an ending time point of the first slot, or the first time being an upper boundary of the first slot, or the first time being a lower boundary of the first slot, or the first time being a first symbol at the end of the first slot.

Optionally, the first time domain symbol is agreed by the protocol, or the first time domain symbol is configured (semi-statically configured or dynamically configured) by the network, or the first time domain symbol is determined by one of the transmitting end or the receiving end, or the first time domain symbol is determined by negotiation between the receiving end and the transmitting end.

For an example, the first time is associated with the first time domain symbol, which may be: the first time being a starting time point of the first time domain symbol, or the first time being an ending time point of the first time domain symbol, or the first time being an upper boundary of the first time domain symbol, or the first time being a lower boundary of the first time domain symbol, or the first time being a first symbol at the end of the first time domain symbol.

Optionally, the first reference time is agreed by the protocol, or the first reference time is configured (semi-statically configured or dynamically configured) by the network, or the first reference time is determined by one of the transmitting end or the receiving end, or the first reference time is determined by negotiation between the receiving end and the transmitting end.

For an example, the first time is associated with the first reference time, which may be: the first time being a time point where the first reference time is located, or the first time being a starting time point of the first reference time, or the first time being an ending time point of the first reference time, or the first time being an upper boundary of the first reference time, or the first time being a lower boundary of the first reference time, or the first time being a first symbol at the end of the first reference time.

In some embodiments, the first event includes but is not limited to at least one of: a data packet arriving, a data packet being transmitted, media access control protocol data unit (MAC PDU) being received, the data packet being received, data packet being successfully decoded, data of the reverse link being received, feedback information of the reverse link being received, auxiliary information being transmitted, the auxiliary information being received, the delay information being received, the time information being received, data of the reverse link being transmitted, the feedback information of the reverse link being transmitted, PDB of the reverse link changing, delay of the reverse link changing, at least one of bi-directional QoS requirement information changing, unidirectional transmission delay of the data packet changing, round-trip delay changing, remaining delay changing, round-trip transmission time (RTT) being reset, PDB of the reverse link being received, PSDB of the reverse link changing, PSDB of the reverse link being received, reverse link information being received, trigger information of the auxiliary information being received, the auxiliary information changing, the trigger information of the auxiliary information being received for the first time, the auxiliary information being transmitted for the first time, or feedback information being transmitted for the first time.

In some embodiments, the first condition includes but is not limited to at least one of: a data packet arriving, the data packet being transmitted, MAC PDU being received, a data packet being received, a data packet being successfully decoded, data of the reverse link being received, feedback information of the reverse link being received, auxiliary information being transmitted, the auxiliary information being received, the delay information being received, time information being received, data of the reverse link being transmitted, feedback information of the reverse link being transmitted, PDB of the reverse link changing, delay of the reverse link changing, at least one of bi-directional QoS requirement information changing or changing to be greater than or equal to a first threshold, unidirectional transmission delay of the data packet changing or changing to be greater than or equal to a second threshold, round-trip delay changing or changing to be greater than or equal to a third threshold, remaining delay changing or changing to be greater than or equal to a fourth threshold, RTT being reset or being reset to be greater than or equal to a fifth threshold, PDB of the reverse link changing or changing to be greater than or equal to a sixth threshold, PDB of the reverse link being received, PSDB of the reverse link changing or changing to be greater than or equal to a seventh threshold, PSDB of the reverse link being received, reverse link information being received, trigger information of the auxiliary information being received, or the auxiliary information changing to be greater than or equal to an eighth threshold.

Optionally, the first threshold may be agreed by the protocol, or the first threshold may be configured (semi-statically configured or dynamically configured) by the network, or the first threshold may be determined by one of the receiving end or the transmitting end, or the first threshold may be determined by negotiation between the receiving end and the transmitting end.

Optionally, the second threshold may be agreed by the protocol, or the second threshold may be configured (semi-statically configured or dynamically configured) by the network, or the second threshold may be determined by one of the receiving end or the transmitting end, or the second threshold may be determined by negotiation between the receiving end and the transmitting end.

Optionally, the third threshold may be agreed by the protocol, or the third threshold may be configured (semi-statically configured or dynamically configured) by the network, or the third threshold may be determined by one of the receiving end or the transmitting end, or the third threshold may be determined by negotiation between the receiving end and the transmitting end.

Optionally, the fourth threshold may be agreed by the protocol, or the fourth threshold may be configured (semi-statically configured or dynamically configured) by the network, or the fourth threshold may be determined by one of the receiving end or the transmitting end, or the fourth threshold may be determined by negotiation between the receiving end and the transmitting end.

Optionally, the fifth threshold may be agreed by the protocol, or the fifth threshold may be configured (semi-statically configured or dynamically configured) by the network, or the fifth threshold may be determined by one of the receiving end or the transmitting end, or the fifth threshold may be determined by negotiation between the receiving end and the transmitting end.

Optionally, the sixth threshold may be agreed by the protocol, or the sixth threshold may be configured (semi-statically configured or dynamically configured) by the network, or the sixth threshold may be determined by one of the receiving end or the transmitting end, or the sixth threshold may be determined by negotiation between the receiving end and the transmitting end.

Optionally, the seventh threshold may be agreed by the protocol, or the seventh threshold may be configured (semi-statically configured or dynamically configured) by the network, or the seventh threshold may be determined by one of the receiving end or the transmitting end, or the seventh threshold may be determined by negotiation between the receiving end and the transmitting end.

Optionally, the eighth threshold may be agreed by the protocol, or the eighth threshold may be configured (semi-statically configured or dynamically configured) by the network, or the eighth threshold may be determined by one of the receiving end or the transmitting end, or the eighth threshold may be determined by negotiation between the receiving end and the transmitting end.

In some embodiments, a delay corresponding to the delay information is an absolute time, or the delay corresponding to the delay information is a relative time, or the delay corresponding to the delay information is a number of SFNs and/or an interval between the SFNs, or the delay corresponding to the delay information is a number of symbols and/or an interval between the symbols, or the delay corresponding to the delay information is a number of slots and/or an interval between the slots.

In some embodiments, the time information includes but is not limited to at least one of: a time when the data packet arrives at the transmitting end (e.g., a time when the data packet transmitted by the receiving end arrives at the transmitting end, or a time when the data packet transmitted by other devices arrives at the transmitting end), a time when the data packet is buffered at the transmitting end (e.g., a time when the data packet transmitted by the receiving end is buffered at the transmitting end, or a time when any data packet is buffered at the transmitting end), a time when the data packet is generated (e.g., a time when the data packet is generated at the transmitting end), a time when the data packet is transmitted (e.g., a time when the transmitting end transmits a certain data packet, or a time when the transmitting end continues to transmit data packets), a time when the data packet is transmitted to the receiving end, a time when the MAC PDU containing the data packet is generated, or timestamp information of the data packet.

In some embodiments, the time information corresponds to real time, or the time information corresponds to a statistical time within a second duration, or the time information is a time corresponding to a second time, or the time information is a time corresponding to a second event and/or a second condition.

In some embodiments, the second duration is agreed by the protocol, or the second duration is configured by the network, or the second duration is determined by one of the transmitting end or the receiving end, or the second duration is determined by negotiation between the receiving end and the transmitting end.

In some embodiments, the second duration is an absolute time, or the second duration is a relative time, or the second duration is associated with a second SFN, or the second duration is associated with a second slot, or the second duration is associated with a second duration domain symbol, or the second duration is associated with a second reference time.

Optionally, the second SFN is agreed by the protocol, or the second SFN is configured (semi-statically configured or dynamically configured) by the network, or the second SFN is determined by one of the transmitting end or the receiving end, or the second SFN is determined by negotiation between the receiving end and the transmitting end.

For an example, the second time is associated with the second SFN, which may be: the second time being a starting time point of the second SFN, or the second time being an ending time point of the second SFN, or the second time being an upper boundary of the second SFN, or the second time being a lower boundary of the second SFN, or the second time being a first symbol at the end of the second SFN.

Optionally, the second slot is agreed by the protocol, or the second slot is configured (semi-statically configured or dynamically configured) by the network, or the second slot is determined by one of the transmitting end or the receiving end, or the second slot is determined by negotiation between the receiving end and the transmitting end.

For an example, the second time is associated with the second slot, which may be: the second time being a starting time point of the second slot, or the second time being an ending time point of the second slot, or the second time being an upper boundary of the second slot, or the second time being a lower boundary of the second slot, or the second time being a first symbol at the end of the second slot.

Optionally, the second time domain symbol is agreed by the protocol, or the second time domain symbol is configured (semi-statically configured or dynamically configured) by the network, or the second time domain symbol is determined by one of the transmitting end or the receiving end, or the second time domain symbol is determined by negotiation between the receiving end and the transmitting end.

For an example, the second time is associated with the second time domain symbol, which may be: the second time being a starting time point of the second time domain symbol, or the second time being an ending time point of the second time domain symbol, or the second time being an upper boundary of the second time domain symbol, or the second time being a lower boundary of the second time domain symbol, or the second time being a first symbol at the end of the second time domain symbol.

Optionally, the second reference time is agreed by the protocol, or the second reference time is configured (semi-statically configured or dynamically configured) by the network, or the second reference time is determined by one of the transmitting end or the receiving end, or the second reference time is determined by negotiation between the receiving end and the transmitting end.

For an example, the second time is associated with the second reference time, which be: the second time being a time point where the second reference time is located, or the second time being a starting time point of the second reference time, or the second time being an ending time point of the second reference time, or the second time being an upper boundary of the second reference time, or the second time being a lower boundary of the second reference time, or the second time being a first symbol at the end of the second reference time.

In some embodiments, the second event includes at least one of: a data packet arriving, a data packet being transmitted, a MAC PDU being received, a data packet being received, a data packet is successfully decoded, data of reverse link being received, feedback information of the reverse link being received, auxiliary information being transmitted, the auxiliary information being received, delay information being received, time information being received, the data of the reverse link being transmitted, feedback information of the reverse link being transmitted, PDB of the reverse link changing, delay of the reverse link changing, at least one of bi-directional QoS requirement information changing, a unidirectional transmission delay of the data packet changing, a round-trip delay changing, a remaining delay changing, RTT being reset, the PDB of the reverse link being received, the PSDB of the reverse link changing, the PSDB of the reverse link being received, information of reverse link being received, trigger information of the auxiliary information being received, the auxiliary information changing, the trigger information of the auxiliary information being received for the first time, the auxiliary information being transmitted for the first time, or feedback information being transmitted for the first time.

In some embodiments, the second condition includes at least one of: a data packet arriving, the data packet being transmitted, MAC PDU being received, the data packet being received, the data packet being successfully decoded, data of reverse link being received, feedback information of reverse link being received, the auxiliary information being transmitted, the auxiliary information being received, the delay information being received, the time information being received, data of the reverse link being transmitted, the feedback information of the reverse link being transmitted, PDB of the reverse link changing, a delay of the reverse link changing, at least one of bi-directional QoS requirement information changing or changing to be greater than or equal to a first threshold, a unidirectional transmission delay of the data packet changing or changing to be greater than or equal to a second threshold, a round-trip delay changing or changing to be greater than or equal to a third threshold, a remaining delay changing or changing to be greater than or equal to a fourth threshold, RTT being reset or being reset to be greater than or equal to a fifth threshold, the PDB of the reverse link changing or changing to be greater than or equal to a sixth threshold, the PDB of the reverse link being received, PSDB of the reverse link changing or changing to be greater than or equal to a seventh threshold, the PSDB of the reverse link being received, information of reverse link being received, trigger information of the auxiliary information being received, or the auxiliary information changing to be greater than or equal to an eighth threshold.

In some embodiments, the delay information and/or the time information is carried by information in the data packet, or the delay information and/or the time information is carried by a data protocol data unit (PDU) of an access stratum (AS), or the delay information and/or the time information is carried by the auxiliary information used for assisting in performing the first operation, or the delay information and/or the time information is carried by terminal auxiliary information from the transmitting end to the receiving end.

In some embodiments, the delay information and/or the time information is carried by a header and/or a load of a data packet, or is carried by control plane information.

In some embodiments, the delay information and/or the time information is dynamic or semi-static.

In some embodiments, the first operation is performed unconditionally.

In some embodiments, the first operation is performed in a case where at least one of the first event, the first condition, the second event, or the second condition is met.

In some embodiments, the bi-directional QoS requirement information is obtained based on pre-configuration information of an application layer or a network device, or the bi-directional QoS requirement information is determined or identified based on the pre-configuration information of the application layer or the network device. Optionally, the pre-configuration information further includes at least one of: identification information of the bi-directional QoS, or an entity or an object or resource information corresponding to the bi-directional QoS. Optionally, the pre-configuration information is transmitted via a Uu interface or a Pc5 interface.

In some embodiments, the bi-directional QoS requirement information is determined or identified based on interactive information between the receiving end and the transmitting end, or the bi-directional QoS requirement information is obtained based on the interactive information between the receiving end and the transmitting end. That is, the bi-directional QoS requirement information may be determined by negotiation between the receiving end and the transmitting end. Optionally, the interaction information further includes at least one of: identification information of the bi-directional QoS, or an entity or an object or resource information corresponding to the bi-directional QoS.

In some embodiments, the bi-directional QoS requirement information is obtained by the receiving end from a higher layer of a bi-directional QoS entity. That is, the receiving end obtains bi-directional QoS requirement information from the higher layer. Optionally, at least one of the following may also be obtained: identification information of the bi-directional QoS, or an entity or an object or resource information corresponding to the bi-directional QoS. Optionally, obtaining from the high layer is an inter-layer interaction.

In some embodiments, the bi-directional QoS requirement information is obtained by the receiving end from a high layer or NAS layer or application layer of the receiving end entity. That is, the receiving end obtains bi-directional QoS requirement information from the higher layer or NAS layer or application layer. Optionally, at least one of the following may also be obtained: identification information of the bi-directional QoS, or an entity or an object or resource information corresponding to the bi-directional QoS. Optionally, obtaining from the high layer is an inter-layer interaction.

In some embodiments, the bi-directional QoS requirement information is obtained from the transmitting end. That is, the receiving end obtains the bi-directional QoS requirement information from the transmitting end. Optionally, the bi-directional QoS requirement information is carried by first information; the first information is one of: information in a data packet received by the receiving end from the transmitting end, terminal auxiliary information from the transmitting end to the receiving end, radio resource control (RRC) information from the transmitting end to the receiving end, media access control layer control element (MAC CE) information from the transmitting end to the receiving end, physical layer information from the transmitting end to the receiving end, or the auxiliary information used for assisting in performing the first operation. Optionally, the first information further includes at least one of: identification information of the bi-directional QoS, or an entity or an object or resource information corresponding to the bi-directional QoS.

In some embodiments, the identification information of the bi-directional QoS is used for identifying an object that performs the bi-directional QoS, or the identification information of the bi-directional QoS is used for indicating that an object having the identification information of the bi-directional QoS performs the bi-directional QoS.

In some embodiments, the entity or the object or the resource information corresponding to the bi-directional QoS includes at least one of: an identifier (ID) of the transmitting end, a group ID to which the transmitting end belongs, an ID of the receiving end, a group ID to which the receiving end belongs, a group ID of the bi-directional QoS, an entity ID of the bi-directional QoS, a terminal ID set of the bi-directional QoS, an entity set of the bi-directional QoS, an object set of the bi-directional QoS, a QoS flow ID, a logical channel (LCH) ID, a logical channel group (LCG) ID, an application ID, a PDU session ID, a DRB ID, a physical channel ID, or a transmission resource set.

In some embodiments, the term “information in the data packet” described in the embodiments of the present application is carried in a header or load of the data packet; the term “auxiliary information” described in the embodiments of the present application is carried by a RRC signaling or MAC CE.

In some embodiments, the bi-directional QoS requirement information is information of QoS flow granularity, or the bi-directional QoS requirement information is information of data packet granularity, or the bi-directional QoS requirement information is information of MAC PDU granularity corresponding to the data packet, or the bi-directional QoS requirement information is information of data burst granularity, or the bi-directional QoS requirement information is information of resource block (RB) granularity, or the bi-directional QoS requirement information is information of LCH granularity, or the bi-directional QoS requirement information is information of LCG granularity, or the bi-directional QoS requirement information is information of PDU session granularity, or the bi-directional QoS requirement information is terminal-specific information, or the bi-directional QoS requirement information is specific information between the transmitting end and the receiving end, or the bi-directional QoS requirement information is application-specific information, or the bi-directional QoS requirement information is terminal group-specific information.

In some embodiments, the first operation is an operation of data packet granularity, or the first operation is an operation of MAC PDU granularity corresponding to the data packet, or the first operation is an operation of QoS flow granularity, or the first operation is an operation of RB granularity, or the first operation is an operation of data burst granularity, or the first operation is an operation of LCH granularity, or the first operation is an operation of LCG granularity, or the first operation is an operation of PDU session granularity, or the first operation is a terminal-specific operation, or the first operation is a specific operation between the transmitting end and the receiving end, or the first operation is an application-specific operation, or the first operation is a terminal group-specific operation.

In some embodiments, the first operation is non-real-time, and/or the first operation is performed periodically, and/or the first operation is performed within a third duration or at a first moment, and/or the first operation is performed in a case where a trigger condition is met, and/or the first operation is performed in a case where a trigger event is met, and/or the first operation is real-time.

In some embodiments, consistent first operations are performed on different objects, or different first operations are performed on different objects.

In some embodiments, the trigger or trigger condition of the first operation is different for different objects, or the trigger or trigger condition of the first operation is the same for different objects.

In some embodiments, in a case where the first operation is the operation of data packet granularity or the operation of MAC PDU granularity corresponding to the data packet, or in a case where the first operation is for the data burst, or in a case where the first operation is for the data packet or the MAC PDU corresponding to the data packet, the first operation is real-time, and/or the first operation is performed in a case where a trigger condition is met, and/or the first operation is performed in a case where a trigger event is met.

For example, in a case where the first operation is the operation of data packet granularity or the operation of MAC PDU granularity corresponding to the data packet, the first operation is real-time, and/or the first operation is performed in a case where a trigger condition is met, and/or the first operation is performed in a case where a trigger event is met.

For another example, in a case where the first operation is for the data burst, the first operation is real-time, and/or the first operation is performed in a case where a trigger condition is met, and/or the first operation is performed in a case where a trigger event is met.

For yet another example, in a case where the first operation is for the data packet or the MAC PDU corresponding to the data packet, the first operation is real-time, and/or the first performed in a case where a trigger event is met.

In some embodiments, in a case where the first operation is the operation of QoS flow granularity or the operation of RB granularity or the operation of LCH granularity or LCG granularity or the operation of PDU session granularity, or in a case where the first operation is the terminal-specific operation, or in a case where the first operation is the specific operation between the transmitting end and the receiving end, or in a case where the first operation is the application-specific operation, or in a case where the first operation is the terminal group-specific operation, the first operation is non-real-time, and/or the first operation is performed periodically, and/or the first operation is performed within a third duration or at a first moment, and/or the first operation is performed in a case where a trigger condition is met, and/or the first operation is performed in a case where a trigger event is met.

For example, in a case where the first operation is the operation of QoS flow granularity or the operation of RB granularity or the operation of LCH granularity or LCG granularity or the operation of PDU session granularity, the first operation is non-real-time, and/or the first operation is performed periodically, and/or the first operation is performed within a third duration or at a first moment, and/or the first operation is performed in a case where a trigger condition is met, and/or the first operation is performed in a case where a trigger event is met.

For another example, in a case where the first operation is the terminal-specific operation, the first operation is non-real-time, and/or the first operation is performed periodically, and/or the first operation is performed within a third duration or at a first moment, and/or the first operation is performed in a case where a trigger condition is met, and/or the first operation is performed in a case where a trigger event is met.

For yet another example, in a case where the first operation is the specific operation between the transmitting end and the receiving end, the first operation is non-real-time, and/or the first operation is performed periodically, and/or the first operation is performed within a third duration or at a first moment, and/or the first operation is performed in a case where a trigger condition is met, and/or the first operation is performed in a case where a trigger event is met.

For yet another example, in a case where the first operation is the application-specific operation, the first operation is non-real-time, and/or the first operation is performed periodically, and/or the first operation is performed within a third duration or at a first moment, and/or the first performed in a case where a trigger event is met.

For yet another example, in a case where the first operation is the terminal group-specific operation, the first operation is non-real-time, and/or the first operation is performed periodically, and/or the first operation is performed within a third duration or at a first moment, and/or the first operation is performed in a case where a trigger condition is met, and/or the first operation is performed in a case where a trigger event is met.

In some embodiments, the third duration is agreed by the protocol, or the third duration is configured by the network, or the third duration is determined by one of the receiving end and the transmitting end, or the third duration is determined by negotiation between the receiving end and the transmitting end.

In some embodiments, the first moment is agreed by the protocol, or the first moment is configured by the network, or the first moment is determined by one of the receiving end and the transmitting end, or the first moment is determined by negotiation between the receiving end and the transmitting end.

In some embodiments, the first operation meets at least one of:
the first operation being an operation that is performed unconditionally;
the first operation being a periodic operation;
the first operation being an event-triggered operation;
the first operation being a condition-triggered operation; or the first operation being performed within the third duration or at the first moment.

For example, the first operation is an operation that is performed periodically within the third duration.

For another example, the first operation is an operation triggered by an event within the third duration.

For yet another example, the first operation is an operation triggered by a condition within the third duration.

For yet another example, the first operation is an operation triggered by an event at the first moment.

For yet another example, the first operation is an operation triggered by a condition at the first moment.

In some embodiments, in a case where the first operation is performed periodically (i.e., the first operation is a periodic operation), periodic information performed by the first operation is agreed by the protocol, or the periodic information performed by the first operation is configured by the network, or the periodic information performed by the first operation is determined by the receiving end, or the periodic information performed by the first operation is determined by the transmitting end, or the periodic information performed by the first operation is determined by negotiation between the receiving end and the transmitting end.

In some embodiments, in a case where the first operation is performed within the third duration or at the first moment, the third duration or the first moment is agreed by the protocol, or the third duration or the first moment is configured by the network, or the third duration or the first moment is determined by the receiving end, or the third duration or the first moment is determined by the transmitting end, or the third duration or the first moment is determined by negotiation between the receiving end and the transmitting end.

In some embodiments, in a case where the first operation is performed in a case where the trigger condition is met (i.e., the first operation is a condition-triggered operation), the condition that triggers performing the first operation includes at least one of: a data packet arriving, a data packet being transmitted, MAC PDU being received, the data packet being received, the data packet being successfully decoded, data of reverse link being received, feedback information of reverse link being received, the auxiliary information being transmitted, the auxiliary information being received, the delay information being received, the time information being received, data of the reverse link being transmitted, the feedback of the reverse link being transmitted, a PDB of the reverse link changing, a delay of reverse linkchanging, at least one of bi-directional QoS requirement information changing or changing to be greater than or equal to a first threshold, a unidirectional transmission delay of the data packet changing or changing to be greater than or equal to a second threshold, a round-trip delay changing or changing to be greater than or equal to a third threshold, a remaining delay changing or changing to be greater than or equal to a fourth threshold, RTT being reseted or the being reseted to be greater than or equal to a fifth threshold, the PDB of the reverse link changing or changing to be greater than or equal to a sixth threshold, the PDB of the reverse link being received, the PSDB of the reverse link changing or changing to be greater than or equal to a seventh threshold, the PSDB of the reverse link being received, information of reverse link being received, trigger information of the auxiliary information being received, or the auxiliary information changing to be greater than or equal to an eighth threshold.

In some embodiments, in a case where the first operation is the event-triggered operation (i.e., the first operation is performed in a case where a trigger event is met), the event that triggers performing the first operation includes at least one of: a data packet arriving, a data packet being transmitted, MAC PDU being received, data packet being received, data packet being successfully decoded, data of reverse link being received, feedback information of the reverse link being received, auxiliary information being transmitted, the auxiliary information being received, the delay information being received, time information being received, data of the reverse link being transmitted, the feedback of the reverse link being transmitted, PDB of the reverse link changing, a delay of the reverse link changing, at least one of bi-directional QoS requirement information changing, a unidirectional transmission delay of the data packet changing, a round-trip delay changing, a remaining delay changing, RTT being reseted, the PDB of the reverse link changing, the PSDB of the reverse link changing, the PSDB of the reverse link being received, information of the reverse link being received, trigger information of the auxiliary information being received, the auxiliary information changing, the trigger information of the auxiliary information being received for the first time, the auxiliary information being transmitted for the first time, or feedback information being transmitted for the first time.

In some embodiments, the first operation is agreed by the protocol, or the first operation is pre-configured or dynamically indicated by the network, or the first operation is performed based on network configuration or pre-configuration, or the first operation is performed based on an indication from the peer end, or the first operation is performed by the receiving end based on the information from the transmitting end, or the first operation is determined by negotiation between the receiving end and the transmitting end.

Therefore, in the embodiments of the present application, in a case of having bi-directional QoS requirement, the receiving end may perform the first operation according to bi-directional QoS requirement information, thereby ensuring the bi-directional QoS requirement to improve the quality of sidelink communication.

The receiving end embodiments of the present application has been described in detail above with reference to FIGS. 4 to 5. The transmitting end embodiments of the present application will be described in detail below with reference to FIG. 6. It should be understood that the transmitting end embodiments and the receiving end embodiments correspond to each other, and similar description may refer to the receiving end embodiment.

FIG. 6 is a schematic flowchart of a wireless communication method 300 according to the embodiments of the present application. As shown in FIG. 6, the wireless communication method 300 may include at least part of the following contents.

In S310, a transmitting end performs a second operation according to bi-directional QoS requirement information on a sidelink; the second operation includes at least one of: transmitting delay information to a receiving end, transmitting time information to the receiving end, transmitting auxiliary information to the receiving end, modifying or determining a forward transmission delay, adjusting or determining a PSDB of a forward link, adjusting or determining a PDB of the forward link, determining delay information, determining time information, determining auxiliary information, determining a remaining delay, deleting packets, determining a recommended PSDB of a reverse link, determining a recommended PDB of the reverse link, adjusting a selected resource set, selecting a transmission resource, selecting a transmission resource set, recommending an optional resource for the receiving end, or recommending an optional resource set for the receiving end.

It should be understood that FIG. 6 shows steps or operations of the wireless communication method 300, but these steps or operations are merely examples, and the embodiments of the present application may also perform other operations or variations of the operations in FIG. 6.

In the embodiments of the present application, in a case of having bi-directional QoS requirement, the transmitting end may perform the second operation according to bi-directional QoS requirement information, thereby ensuring the bi-directional QoS requirement to improve the quality of sidelink communication.

In the embodiments of the present application, the receiving end may also be referred to as a receiving end device, and the transmitting end may also be referred to as a transmitting end device. Optionally, the receiving end may be a terminal device, a receiving terminal, or a relay, and the transmitting end may be a terminal device, a transmitting terminal, or a relay. Optionally, the receiving end and the transmitting end communicate directly via the sidelink, or the receiving end and the transmitting end communicate via a relay link.

In the embodiments of the present application, a link from the transmitting end to the receiving end is a forward link, and a link from the receiving end to the transmitting end is a reverse link, as shown in FIG. 5.

In the embodiments of the present application, a peer end or multiple parties for the bi-directional QoS requirement may be explicitly indicated (for example, two parties pre-configured by an application layer or a network, or a group pre-configured by the application layer or the network, or a peer end or multiple parties involved in the interaction between the transmitting end and the receiving end or configured to perform the second operation), or may be implicitly determined (for example, whether configured QoS parameters include bi-directional QoS parameters, or whether bi-directional QoS is enabled, or a peer end or multiple parties that transmit and/or receive the bi-directional QoS requirement, a peer end or multiple parties that perform the second operation).

In some embodiments, the bi-directional QoS requirement information is dynamic or semi-static.

For example, the second operation includes transmitting at least one of the delay information, the time information, or the auxiliary information to the receiving end. Thus, in a case of having the bi-directional QOS requirement, the receiving end may perform a sidelink transmission according to at least one of the delay information, the time information, or the auxiliary information, so that the reverse link transmission may be optimized.

For example, the second operation includes transmitting at least one of the delay information, the time information, or the auxiliary information to the receiving end, or determining the recommended PSDB of the reverse link. Thus, in a case of having the bi-directional QoS requirement, the receiving end may perform a sidelink transmission according to at least one of the delay information, the time information, or the auxiliary information, and the recommended reverse link PSDB, so that the reverse link transmission may be optimized.

For example, the second operation includes transmitting at least one of the delay information, the time information, or the auxiliary information to the receiving end, and determining the recommended PDB of the reverse link. Thus, in a case of having the bi-directional QOS requirement, the receiving end may perform a sidelink transmission according to at least one of the delay information, the time information, or the auxiliary information, and the recommended PDB of the reverse link, so that the reverse link transmission may be optimized.

For example, the second operation includes transmitting at least one of the delay information, the time information, or the auxiliary information to the receiving end, and determining the recommended PDB and the PSDB of the reverse link. Thus, in a case of having the bi-directional QoS requirement, the receiving end may perform the sidelink transmission according to at least one of the delay information, the time information, or the auxiliary information, and the recommended PDB and PSDB of the reverse link, so that the reverse link transmission may be optimized.

For example, the second operation includes determining the recommended PDB and/or the PSDB of the reverse link, and recommending the optional resource and/or optional resource set for the receiving end. Thus, in a case of having the bi-directional QoS requirement, the receiving end may perform the sidelink transmission according to the recommended PDB and PSDB of the reverse link, the recommended optional resources and/or optional resource sets, so that the reverse link transmission may be optimized.

For example, the second operation includes modifying or determining the forward transmission delay. Thus, in a case of having the bi-directional QoS requirement, the receiving end may modify or determine the forward transmission delay based on the bi-directional QoS requirement information, so that the forward link transmission may be optimized.

For example, the second operation includes modifying or determining the forward transmission delay, adjusting or determining the PSDB of the forward link. Thus, in a case of having the bi-directional QoS requirement, the receiving end may modify or determine the forward transmission delay, and adjust or determine the PSDB of the forward link based on the bi-directional QoS requirement information, so that the forward link transmission may be optimized.

For example, the second operation includes modifying or determining the forward transmission delay, adjusting or determining the PSDB of the forward link, and deleting packets. Thus, in a case of having the bi-directional QoS requirement, the receiving end may modify or determine the forward transmission delay, adjust or determine the PSDB of the forward link, and delete packets based on the bi-directional QoS requirement information, so that the forward link transmission may be optimized.

For example, the second operation includes modifying or determining the forward transmission delay, adjusting or determining the PDB of the forward link. Thus, in a case of having the bi-directional QoS requirement, the receiving end may modify or determine the forward transmission delay, and adjust or determine the PDB of the forward link based on the bi-directional QoS requirement information, so that the forward link transmission may be optimized.

For example, the second operation includes modifying or determining the forward transmission delay, adjusting or determining the PDB of the forward link, and deleting packets. Thus, in a case of having the bi-directional QOS requirement, the receiving end may modify or determine the forward transmission delay, adjust or determine the PDB of the forward link, and delete packets based on the bi-directional QoS requirement information, so that the forward link transmission may be optimized.

For example, the second operation includes modifying or determining the forward transmission delay, adjusting or determining the PDB of the forward link, and adjusting the selected resource and/or resource set. Thus, in a case of having the bi-directional QoS requirement, the receiving end may modify or determine the forward transmission delay, adjust or determine the PDB of the forward link, and adjust the selected resource and/or resource set based on the bi-directional QoS requirement information, so that the forward link transmission may be optimized.

For example, the second operation includes modifying or determining the forward transmission delay, adjusting or determining the PDB of the forward link, adjusting the selected resource and/or resource set, and deleting packets. Thus, in a case of having the bi-directional QoS requirement, the receiving end may modify or determine the forward transmission delay, adjust or determine the PDB of the forward link, adjust the selected resource and/or resource set, and delete packets based on the bi-directional QoS requirement information, so that the forward link transmission may be optimized.

For example, the second operation includes determining the remaining delay. Thus, in a case of having the bi-directional QoS requirement, the transmitting end may determine/adjust the PDB of the forward link and/or reverse link according to the bi-directional QoS requirement information, so that the receiving end may perform more reasonable transmission on the reverse link, and/or the transmitting end may perform more reasonable transmission on the forward link.

For example, the second operation includes determining the remaining delay. Thus, in a case of having the bi-directional QoS requirement, the transmitting end may determine/adjust the PSDB of the reverse link and/or forward link according to the bi-directional QoS requirement information, so that the receiving end may perform more reasonable transmission on the reverse link, and/or the transmitting end may perform more reasonable transmission on the forward link.

For example, the second operation includes determining the remaining delay. Thus, in a case of having the bi-directional QoS requirement, the transmitting end may adjust the selected resource and/or resource set according to the bi-directional QoS requirement information, so that the receiving end may perform more reasonable transmission on the reverse link, and/or the transmitting end may perform more reasonable transmission on the forward link.

For example, the second operation includes determining the remaining delay. Thus, in a case of having the bi-directional QoS requirement, the transmitting end may select transmission resource and/or resource set according to the bi-directional QoS requirement information, so that the receiving end may perform more reasonable transmission on the reverse link, and/or the transmitting end may perform more reasonable transmission on the forward link.

For example, the second operation includes determining the remaining delay. Thus, in a case of having the bi-directional QoS requirement, the transmitting end may delete packets according to the bi-directional QoS requirement information, so that the receiving end may perform more reasonable transmission on the reverse link, and/or the transmitting end may perform more reasonable transmission on the forward link.

For example, the second operation includes determining the remaining delay. Thus, in a case of having the bi-directional QoS requirement, the transmitting end may determine the recommended PSDB of the reverse link according to the bi-directional QoS requirement information, so that the receiving end may perform more reasonable transmission on the reverse link, and/or the transmitting end may perform more reasonable transmission on the forward link.

For example, the second operation includes determining the remaining delay. Thus, in a case of having the bi-directional QoS requirement, the transmitting end may determine the recommended PDB of the reverse link according to the bi-directional QOS requirement information, so that the receiving end may perform more reasonable transmission on the reverse link, and/or the transmitting end may perform more reasonable transmission on the forward link.

For example, the second operation includes determining the remaining delay. Thus, in a case of having the bi-directional QoS requirement, the transmitting end may determine the delay information according to the bi-directional QoS requirement information, so that the receiving end may perform more reasonable transmission on the reverse link, and/or the transmitting end may perform more reasonable transmission on the forward link.

For example, the second operation includes determining the remaining delay. Thus, in a case of having the bi-directional QoS requirement, the transmitting end may determine the time information according to the bi-directional QoS requirement information, so that the receiving end may perform more reasonable transmission on the reverse link, and/or the transmitting end may perform more reasonable transmission on the forward link.

For example, the second operation includes determining the remaining delay. Thus, in a case of having the bi-directional QoS requirement, the transmitting end may determine the auxiliary information according to the bi-directional QoS requirement information, so that the receiving end may perform more reasonable transmission on the reverse link, and/or the transmitting end may perform more reasonable transmission on the forward link.

For example, the second operation includes determining the remaining delay. Thus, in a case of having the bi-directional QoS requirement, the transmitting end may recommend the optional resources of the receiving end according to the bi-directional QOS requirement information, so that the receiving end may perform more reasonable transmission on the reverse link, and/or the transmitting end may perform more reasonable transmission on the forward link.

For example, the second operation includes determining the remaining delay. Thus, in a case of having the bi-directional QoS requirement, the transmitting end may recommend the optional resource sets of the receiving end according to the bi-directional QoS requirement information, so that the receiving end may perform more reasonable transmission on the reverse link, and/or the transmitting end may perform more reasonable transmission on the forward link.

For example, the second operation includes determining the time information, and/or determining the delay information, and/or determining the auxiliary information. Optionally, the time information and/or the delay information and/or the auxiliary information may be obtained by the transmitting end from the receiving end, or may be determined by the transmitting end according to information from the receiving end, or may be determined by the transmitting end according to information from the network, or may be evaluated by the transmitting end itself.

For example, the second operation includes determining the time information, and/or determining the delay information, and/or determining the auxiliary information. Thus, in a case of having the bi-directional QoS requirement, the transmitting end may determine/adjust the PDB of the reverse link and/or forward link according to the bi-directional QoS requirement information, so that the receiving end may perform more reasonable transmission on the reverse link, and/or the transmitting end may perform more reasonable transmission on the forward link.

For example, the second operation includes determining the time information, and/or determining the delay information, and/or determining the auxiliary information. Thus, in a case of having the bi-directional QoS requirement, the transmitting end may determine/adjust the PSDB of the reverse link and/or forward link according to the bi-directional QoS requirement information, so that the receiving end may perform more reasonable transmission on the reverse link, and/or the transmitting end may perform more reasonable transmission on the forward link.

For example, the second operation includes determining the time information, and/or determining the delay information, and/or determining the auxiliary information. Thus, in a case of having the bi-directional QoS requirement, the transmitting end may adjust the selected resource and/or resource set according to the bi-directional QoS requirement information, so that the receiving end may perform more reasonable transmission on the reverse link, and/or the transmitting end may perform more reasonable transmission on the forward link.

For example, the second operation includes determining the time information, and/or determining the delay information, and/or determining the auxiliary information. Thus, in a case of having the bi-directional QoS requirement, the transmitting end may select transmission resource and/or resource set according to the bi-directional QoS requirement information, so that the receiving end may perform more reasonable transmission on the reverse link, and/or the transmitting end may perform more reasonable transmission on the forward link.

For example, the second operation includes determining the time information, and/or determining the delay information, and/or determining the auxiliary information. Thus, in a case of having the bi-directional QoS requirement, the transmitting end may delete packets according to the bi-directional QoS requirement information, so that the receiving end may perform more reasonable transmission on the reverse link, and/or the transmitting end may perform more reasonable transmission on the forward link.

For example, the second operation includes determining the time information, and/or determining the delay information, and/or determining the auxiliary information. Thus, in a case of having the bi-directional QOS requirement, the transmitting end may perform feedback according to the bi-directional QoS requirement information, so that the receiving end may perform more reasonable transmission on the reverse link, and/or the transmitting end may perform more reasonable transmission on the forward link.

For example, the second operation includes determining the time information, and/or determining the delay information, and/or determining the auxiliary information. Thus, in a case of having the bi-directional QoS requirement, the transmitting end may determine the remaining delay according to the bi-directional QoS requirement information, so that the receiving end may perform more reasonable transmission on the reverse link, and/or the transmitting end may perform more reasonable transmission on the forward link.

For example, the second operation includes transmitting the delay information to the receiving end, and/or transmitting the time information to the receiving end, and/or transmitting the auxiliary information to the receiving end. Thus, in a case of having the bi-directional QoS requirement, the receiving end may determine/adjust the PDB of the reverse link and/or forward link according to the bi-directional QoS requirement information, so that the receiving end may perform more reasonable transmission on the reverse link, and/or the transmitting end may perform more reasonable transmission on the forward link.

For example, the second operation includes transmitting the delay information to the receiving end, and/or transmitting the time information to the receiving end, and/or transmitting the auxiliary information to the receiving end. Thus, in a case of having the bi-directional QoS requirement, the receiving end may determine/adjust the PSDB of the reverse link and/or forward link according to the bi-directional QoS requirement information, so that the receiving end may perform more reasonable transmission on the reverse link, and/or the transmitting end may perform more reasonable transmission on the forward link.

For example, the second operation includes transmitting the delay information to the receiving end, and/or transmitting the time information to the receiving end, and/or transmitting the auxiliary information to the receiving end. Thus, in a case of having the bi-directional QoS requirement, the receiving end may adjust the selected resource and/or resource set according to the bi-directional QoS requirement information, so that the receiving end may perform more reasonable transmission on the reverse link, and/or the transmitting end may perform more reasonable transmission on the forward link.

For example, the second operation includes transmitting the delay information to the receiving end, and/or transmitting the time information to the receiving end, and/or transmitting the auxiliary information to the receiving end. Thus, in a case of having the bi-directional QoS requirement, the receiving end may select transmission resource and/or resource set according to the bi-directional QoS requirement information, so that the receiving end may perform more reasonable transmission on the reverse link, and/or the transmitting end may perform more reasonable transmission on the forward link.

For example, the second operation includes transmitting the delay information to the receiving end, and/or transmitting the time information to the receiving end, and/or transmitting the auxiliary information to the receiving end. Thus, in a case of having the bi-directional QoS requirement, the receiving end may delete packets according to the bi-directional QOS requirement information, so that the receiving end may perform more reasonable transmission on the reverse link, and/or the transmitting end may perform more reasonable transmission on the forward link.

For example, the second operation includes transmitting the delay information to the receiving end, and/or transmitting the time information to the receiving end, and/or transmitting the auxiliary information to the receiving end. Thus, in a case of having the bi-directional QoS requirement, the receiving end may perform feedback according to the bi-directional QoS requirement information, so that the receiving end may perform more reasonable transmission on the reverse link, and/or the transmitting end may perform more reasonable transmission on the forward link.

For example, the second operation includes transmitting the delay information to the receiving end, and/or transmitting the time information to the receiving end, and/or transmitting the auxiliary information to the receiving end. Thus, in a case of having the bi-directional QoS requirement, the receiving end may determine the remaining delay according to the bi-directional QoS requirement information, so that the receiving end may perform more reasonable transmission on the reverse link, and/or the transmitting end may perform more reasonable transmission on the forward link.

In some embodiments, in a case where the second operation includes determining the remaining delay, the transmitting end may determine the remaining delay of the reverse link and/or the forward link.

In some embodiments, in a case where the second operation includes adjusting the selected resource (i.e., a resource transmitted from the transmitting end to the receiving end), adjusting the selected resource includes but is not limited to at least one of: determining a resource for transmission, determining an available resource in a candidate resource set, determining a priority of the resource in the candidate resource set, or adjusting a priority of the available resource in selection.

In some embodiments, in a case where the second operation includes adjusting the selected resource set (i.e., a resource set transmitted from the transmitting end to the receiving end), adjusting the selected resource set includes but is not limited to at least one of: determining a resource set for transmission, determining an available resource set in a candidate resource set, or adjusting a priority of the available resource set in selection.

In some embodiments, in a case where the second operation includes selecting the transmission resource (i.e., a resource transmitted from the transmitting end to the receiving end), selecting the transmission resource includes but is not limited to at least one of the following: selecting the transmission resource from the candidate resources, or selecting the transmission resource from the candidate resource set.

In some embodiments, in a case where the second operation includes selecting the transmission resource set (i.e., a resource set transmitted from the transmitting end to the receiving end), selecting the transmission resource set includes: selecting the transmission resource set from the candidate resource sets.

In some embodiments, recommending the optional resource for the receiving end includes but is not limited to at least one of: recommending the optional resource for data transmitted from the receiving end to the transmitting end, recommending the optional resource for the data packet transmitted from the receiving end to the transmitting end, recommending the optional resource for information transmitted from the transmitting end to the receiving end, or recommending the transmission resource for the data packet or information transmitted from the receiving end to the transmitting end.

In some embodiments, recommending the optional resource set for the receiving end includes but is not limited to at least one of: recommending the optional resource set for the data transmitted from the receiving end to the transmitting end, recommending the optional resource set for the data packet transmitted from the receiving end to the transmitting end, recommending the optional resource set for information transmitted from the transmitting end to the receiving end, or recommending the transmission resource set for the data packets or information transmitted from the receiving end to the transmitting end.

In some embodiments, the delay information includes but is not limited to at least one of: a bi-directional transmission delay, a bi-directional PDB, a PDB of the reverse link recommended by the transmitting end, a bi-directional PSDB, a PSDB of the reverse link recommended by the transmitting end, a remaining delay determined by the transmitting end, or a delay used/occupied by the transmitting end.

Optionally, the bi-directional PDB may be the PDB of the forward link and the reverse link.

Optionally, the bi-directional PSDB may be the PSDB of the forward link and the reverse link.

In some embodiments, in a case where the second operation includes adjusting the PSDB, the transmitting end may adjust the PSDB of the forward link based on preset PSDB parameters, or the transmitting end may adjust the PSDB of the forward link based on the PSDB parameters determined by negotiation between the receiving end and the transmitting end, or the transmitting end may autonomously decide how to adjust the PSDB of the forward link.

In some embodiments, in a case where the second operation includes adjusting the PDB, the transmitting end may adjust the PSDB of the forward link based on preset PDB parameters, or the transmitting end may adjust the PDB of the forward link based on the PDB parameters determined by negotiation between the receiving end and the transmitting end, or the transmitting end may autonomously decide how to adjust the PDB of the forward link.

In some embodiments, both the PSDB of the forward link and the PDB of the forward link may be determined/adjusted, or only the PSDB of the forward link may be determined/adjusted, or only the PDB of the forward link may be determined/adjusted.

In some embodiments, if a PSDB exists, or an indication is given to determine the PSDB, only the PSDB of the forward link is determined/adjusted, or the PSDB of the forward link is determined/adjusted, or the PDB of the forward link is not determined/adjusted.

In some embodiments, if PDB exists, or an indication is given to determine the PDB, only the PDB of the forward link is determined/adjusted, or the PDB of the forward link is determined/adjusted, or the PSDB of the forward link is not determined/adjusted.

In some embodiments, if PSDB does not exists, or an indication is given not to determine the PSDB, only the PDB of the forward link is determined/adjusted, or the PDB of the forward link is determined/adjusted, or the PSDB of the forward link is not determined/adjusted.

In some embodiments, in a case where the second operation includes recommending the PSDB of the reverse link, the transmitting end may recommend the PSDB of the reverse link based on preset PSDB parameters, or the transmitting end may recommend the PSDB of the reverse link based on PSDB parameters determined by negotiation between the receiving end and the transmitting end, or the transmitting end may autonomously decide how to recommend the PSDB of the reverse link.

In some embodiments, in a case where the second operation includes recommending the PDB of the reverse link, the transmitting end may recommend the PDB of the reverse link based on preset PDB parameters, or the transmitting end may recommend the PDB of the reverse link based on PDB parameters determined by negotiation between the receiving end and the transmitting end, or the transmitting end may autonomously decide how to recommend the PDB of the reverse link.

In some embodiments, both the PSDB of the reverse link and the PDB of the reverse link may be determined/recommended, or only PSDB of the reverse link may be determined/recommended, or only the PDB of the reverse link may be determined/recommended.

In some embodiments, if a PSDB exists, or an indication is given to determine the PSDB, only the PSDB of the reverse link is determined/recommended, or the PSDB of the reverse link is determined/recommended, or the PDB of the reverse link is not determined/recommended.

In some embodiments, if a PDB exists, or an indication is given to determine the PDB, only the PDB of the reverse link is determined/recommended, or the PDB of the reverse link is determined/recommended, or the PSDB of the reverse link is not determined/recommended.

In some embodiments, if a PSDB does not exists, or an indication is given not to determine the PSDB, only the PDB of the reverse link is determined/recommended, or the PDB of the reverse link is determined/recommended, or the PSDB of the reverse link is not determined/recommended.

In some embodiments, in a case where the second operation includes deleting packets, the transmitting end may delete the data packet or data to be transmitted or buffered. The data or data packet to be transmitted or buffered may be data or data packet transmitted via the forward link, or data or data packet submitted to a higher layer (e.g., a NAS, or an application layer).

In some embodiments, in a case where the second operation includes deleting packets, the transmitting end may request the receiving end or the peer end to transmit packet deletion auxiliary information. The packet deletion auxiliary information is used for the transmitting end performing a packet deletion operation. The auxiliary information includes but is not limited to sequence numbers.

In some embodiments, in a case where the second operation includes deleting packets, the transmitting end may transmit packet deletion information to the receiving end or the peer end.

The packet deletion information is used to indicate the packet information deleted by the transmitting end. The packet deletion information includes but is not limited to sequence numbers.

For an example, the remaining delay determined by the transmitting end may be the remaining delay of the forward link and/or the remaining delay of the reverse link.

In some embodiments, the delay information corresponds to a real-time delay, or the delay information corresponds to a statistical delay within a first duration, or the delay information is a delay corresponding to a first time, or the delay information is a delay corresponding to a first event and/or a first condition.

In some embodiments, the first duration is agreed by the protocol, or the first duration is configured (semi-statically configured or dynamically configured) by the network, or the first duration is determined by negotiation between the receiving end and the transmitting end.

In some embodiments, the first time is an absolute time, or the first time is a relative time, or the first time is associated with a first SFN, or the first time is associated with a first slot, or the first time is associated with a first time domain symbol, or the first time is associated with a first reference time.

Optionally, the first SFN is agreed by the protocol, or the first SFN is configured (semi-statically configured or dynamically configured) by the network, or the first SFN is determined by one of the transmitting end or the receiving end, or the first SFN is determined by negotiation between the receiving end and the transmitting end.

For an example, the first time is associated with the first SFN, which may be: the first time being a starting time point of the first SFN, or the first time being an ending time point of the first SFN, or the first time being an upper boundary of the first SFN, or the first time being a lower boundary of the first SFN, or the first time being a first symbol at the end of the first SFN.

Optionally, the first slot is agreed by the protocol, or the first slot is configured (semi-statically configured or dynamically configured) by the network, or the first slot is determined by one of the transmitting end or the receiving end, or the first slot is determined by negotiation between the receiving end and the transmitting end.

For an example, the first time is associated with the first slot, which may be: the first time being a starting time point of the first slot, or the first time being an ending time point of the first slot, or the first time being an upper boundary of the first slot, or the first time being a lower boundary of the first slot, or the first time being a first symbol at the end of the first slot.

Optionally, the first time domain symbol is agreed by the protocol, or the first time domain symbol is configured (semi-statically configured or dynamically configured) by the network, or the first time domain symbol is determined by one of the transmitting end or the receiving end, or the first time domain symbol is determined by negotiation between the receiving end and the transmitting end.

For an example, the first time is associated with the first time domain symbol, which may be: the first time being a starting time point of the first time domain symbol, or the first time being an ending time point of the first time domain symbol, or the first time being an upper boundary of the first time domain symbol, or the first time being a lower boundary of the first time domain symbol, or the first time being a first symbol at the end of the first time domain symbol.

Optionally, the first reference time is agreed by the protocol, or the first reference time is configured (semi-statically configured or dynamically configured) by the network, or the first reference time is determined by one of the transmitting end or the receiving end, or the first reference time is determined by negotiation between the receiving end and the transmitting end.

For an example, the first time is associated with the first reference time, which may be: the first time being a time point where the first reference time is located, or the first time being a starting time point of the first reference time, or the first time being an ending time point of the first reference time, or the first time being an upper boundary of the first reference time, or the first time being a lower boundary of the first reference time, or the first time being a first symbol at the end of the first reference time.

In some embodiments, the first event includes but is not limited to at least one of: a data packet arriving, a data packet being transmitted, MAC PDU reception, a data packet being received, a data packet being successfully decoded, data of reverse link being received, feedback information of the reverse link being received, the auxiliary information being transmitted, the auxiliary information being received, the delay information being received, the time information being received, data of the reverse link being transmitted, the feedback information of the reverse link being transmitted, the PDB of the reverse link changing, a delay of the reverse link changing, at least one of bi-directional QoS requirement information changing, a unidirectional transmission delay of the data packet changing, a round-trip delay changing, a remaining delay changing, RTT being reset, the PDB of the reverse link being received, the PSDB of the reverse link changing, the PSDB of the reverse link being received, information of reverse link being received, trigger information of the auxiliary information being received, the auxiliary information changing, the trigger information of the auxiliary information being received for the first time, the auxiliary information being transmitted for the first time, or feedback information being transmitted for the first time.

In some embodiments, the first condition includes but is not limited to at least one of: a data packet arriving, a data packet transmission being transmitted, MAC PDU being received, a data packet being received, a data packet being successfully decoded, data of reverse link being received, feedback information of reverse link being received, the auxiliary information being transmitted, the auxiliary information being received, the delay information being received, the time information being received, data of the reverse link being transmitted, feedback information of the reverse link being transmitted, the PDB of the reverse link changing, delay reverse link changing, at least one of bi-directional QoS requirement information changing or changing to be greater than or equal to a first threshold, a unidirectional transmission delay of the data packet changing or changing to be greater than or equal to a second threshold, a round-trip delay changing or changing to be greater than or equal to a third threshold, a remaining delay changing or changing to be greater than or equal to a fourth threshold, RTT being reset or being reset to be greater than or equal to a fifth threshold, the PDB of the reverse link changing or changing to be greater than or equal to a sixth threshold, the PDB of the reverse link being received, the PSDB of the reverse link changing or changing to be greater than or equal to a seventh threshold, the PSDB of the reverse link being received, information of reverse link being received, trigger information of the auxiliary information being received, or the auxiliary information changing to be greater than or equal to an eighth threshold.

Optionally, the first threshold may be agreed by the protocol, or the first threshold may be configured (semi-statically configured or dynamically configured) by the network, or the first threshold may be determined by one of the receiving end or the transmitting end, or the first threshold may be determined by negotiation between the receiving end and the transmitting end.

Optionally, the second threshold may be agreed by the protocol, or the second threshold may be configured (semi-statically configured or dynamically configured) by the network, or the second threshold may be determined by one of the receiving end or the transmitting end, or the second threshold may be determined by negotiation between the receiving end and the transmitting end.

Optionally, the third threshold may be agreed by the protocol, or the third threshold may be configured (semi-statically configured or dynamically configured) by the network, or the third threshold may be determined by one of the receiving end or the transmitting end, or the third threshold may be determined by negotiation between the receiving end and the transmitting end.

Optionally, the fourth threshold may be agreed by the protocol, or the fourth threshold may be configured (semi-statically configured or dynamically configured) by the network, or the fourth threshold may be determined by one of the receiving end or the transmitting end, or the fourth threshold may be determined by negotiation between the receiving end and the transmitting end.

Optionally, the fifth threshold may be agreed by the protocol, or the fifth threshold may be configured (semi-statically configured or dynamically configured) by the network, or the fifth threshold may be determined by one of the receiving end or the transmitting end, or the fifth threshold may be determined by negotiation between the receiving end and the transmitting end.

Optionally, the sixth threshold may be agreed by the protocol, or the sixth threshold may be configured (semi-statically configured or dynamically configured) by the network, or the sixth threshold may be determined by one of the receiving end or the transmitting end, or the sixth threshold may be determined by negotiation between the receiving end and the transmitting end.

Optionally, the seventh threshold may be agreed by the protocol, or the seventh threshold may be configured (semi-statically configured or dynamically configured) by the network, or the seventh threshold may be determined by one of the receiving end or the transmitting end, or the seventh threshold may be determined by negotiation between the receiving end and the transmitting end.

Optionally, the eighth threshold may be agreed by the protocol, or the eighth threshold may be configured (semi-statically configured or dynamically configured) by the network, or the eighth threshold may be determined by one of the receiving end or the transmitting end, or the eighth threshold may be determined by negotiation between the receiving end and the transmitting end.

In some embodiments, a delay corresponding to the delay information is an absolute time, or the delay corresponding to the delay information is a relative time, or the delay corresponding to the delay information is a number of SFNs and/or an interval between the SFNs s, or the delay corresponding to the delay information is a number of symbols and/or an interval between the symbols, or the delay corresponding to the delay information is a number of slots and/or an interval between the slots.

In some embodiments, the time information includes but is not limited to at least one of: a time when the data packet arrives at the transmitting end (e.g., a time when the data packet transmitted by the receiving end arrives at the transmitting end, or a time when the data packet transmitted by other devices arrives at the transmitting end), a time when the data packet is buffered at the transmitting end (e.g., a time when the data packet transmitted by the receiving end is buffered at the transmitting end, or a time when any data packet is buffered at the transmitting end), a time when the data packet is generated (e.g., a time when the data packet is generated at the transmitting end), a time when the data packet is transmitted (e.g., a time when the transmitting end transmits a certain data packet, or a time when the transmitting end continues to transmit data packets), a time when the data packet is transmitted to the receiving end, a time when the MAC PDU containing the data packet is generated, or timestamp information of the data packet.

In some embodiments, the time information corresponds to real time, or the time information corresponds to a statistical time within a second duration, or the time information is a time corresponding to a second time, or the time information is a time corresponding to a second event and/or a second condition.

In some embodiments, the second duration is agreed by the protocol, or the second duration is configured by the network, or the second duration is determined by one of the transmitting end or the receiving end, or the second duration is determined by negotiation between the receiving end and the transmitting end.

In some embodiments, the second duration is an absolute time, or the second duration is a relative time, or the second duration is associated with a second SFN, or the second duration is associated with a second slot, or the second duration is associated with a second duration domain symbol, or the second duration is associated with a second reference time.

Optionally, the second SFN is agreed by the protocol, or the second SFN is configured (semi-statically configured or dynamically configured) by the network, or the second SFN is determined by one of the transmitting end or the receiving end, or the second SFN is determined by negotiation between the receiving end and the transmitting end.

For an example, the second time is associated with the second SFN, which may be: the second time being a starting time point of the second SFN, or the second time being an ending time point of the second SFN, or the second time being an upper boundary of the second SFN, or the second time being a lower boundary of the second SFN, or the second time being a first symbol at the end of the second SFN.

Optionally, the second slot is agreed by the protocol, or the second slot is configured (semi-statically configured or dynamically configured) by the network, or the second slot is determined by one of the transmitting end or the receiving end, or the second slot is determined by negotiation between the receiving end and the transmitting end.

For an example, the second time is associated with the second slot, which may be: the second time being a starting time point of the second slot, or the second time being an ending time point of the second slot, or the second time being an upper boundary of the second slot, or the second time being a lower boundary of the second slot, or the second time being a first symbol at the end of the second slot.

Optionally, the second time domain symbol is agreed by the protocol, or the second time domain symbol is configured (semi-statically configured or dynamically configured) by the network, or the second time domain symbol is determined by one of the transmitting end or the receiving end, or the second time domain symbol is determined by negotiation between the receiving end and the transmitting end.

For an example, the second time is associated with the second time domain symbol, which may be: the second time being a starting time point of the second time domain symbol, or the second time being an ending time point of the second time domain symbol, or the second time being an upper boundary of the second time domain symbol, or the second time being a lower boundary of the second time domain symbol, or the second time being a first symbol at the end of the second time domain symbol.

Optionally, the second reference time is agreed by the protocol, or the second reference time is configured (semi-statically configured or dynamically configured) by the network, or the second reference time is determined by one of the transmitting end or the receiving end, or the second reference time is determined by negotiation between the receiving end and the transmitting end.

For an example, the second time is associated with the second reference time, which may be: the second time being a time point where the second reference time is located, or the second time being a starting time point of the second reference time, or the second time being an ending time point of the second reference time, or the second time being an upper boundary of the second reference time, or the second time being a lower boundary of the second reference time, or the second time being a first symbol at the end of the second reference time.

In some embodiments, the second event includes at least one of: a data packet arriving, a data packet being transmitted, MAC PDU being received, the data packet being received, the data packet being successfully decoded, data of reverse link being received, feedback information of the reverse link being received, the auxiliary information being transmitted, the auxiliary information being received, the delay information being received, the time information being received, data of the reverse link being transmitted, the feedback information of the reverse link being transmitted, the PDB of the reverse link changing, delay of the reverse link changing, at least one of bi-directional QoS requirement information changing, a unidirectional transmission delay of the data packet changing, a round-trip delay changing, a remaining delay changing, a RTT being reset, the PDB of the reverse link changing, the PDB of the reverse link being received, the PSDB of the reverse link changing, the PSDB of the reverse link being received, information of reverse link being received, trigger information of the auxiliary information being received, the auxiliary information changing, the trigger information of the auxiliary information being received for the first time, the auxiliary information being transmitted for the first time, or feedback information being transmitted for the first time.

In some embodiments, the second condition includes at least one of: a data packet arriving, a data packet being transmitted, MAC PDU being received, the data packet being received, data packet being successfully decoded, data of reverse link being received, feedback information of reverse link being received, the auxiliary information being transmitted, the auxiliary information being received, the delay information being received, the time information being received, data of the reverse link being transmitted, the feedback information of the reverse link being transmitted, the PDB of the reverse link changing, a delay of the reverse link changing, at least one of bi-directional QoS requirement information changing or changing to be greater than or equal to a first threshold, a unidirectional transmission delay of the data packet changing or changing to be greater than or equal to a second threshold, a round-trip delay changing or changing to be greater than or equal to a third threshold, a remaining delay changing or changing to be greater than or equal to a fourth threshold, RTT being reset or being reset to be greater than or equal to a fifth threshold, the PDB of the reverse link changing or changing to be greater than or equal to a sixth threshold, the PDB of the reverse link being received, the PSDB of the reverse link changing or changing to be greater than or equal to a seventh threshold, the PSDB of the reverse link being received, information of the reverse link being received, trigger information of the auxiliary information being received, or the auxiliary information changing to be greater than or equal to an eighth threshold.

In some embodiments, the delay information and/or the time information is carried by information in the data packet, or the delay information and/or the time information is carried by a data PDU of an AS, or the delay information and/or the time information is carried by the auxiliary information used for assisting in performing the second operation, or the delay information and/or the time information is carried by terminal auxiliary information from the transmitting end to the receiving end.

In some embodiments, the bi-directional QoS requirement information includes but is not limited to at least one of: RTT, or indication information for enabling or disabling the bi-directional QoS requirement. For example, the indication information for enabling or disabling the bi-directional QoS requirement may occupy one bit; a value of 0 indicates enabling the bi-directional QoS requirement, and a value of 1 indicates disabling the bi-directional QoS requirement; alternatively, a value of 1 indicates enabling the bi-directional QoS requirement, and a value of 0 indicates disabling the bi-directional QoS requirement.

In some embodiments, the delay information and/or the time information is carried by a header and/or a load of a data packet, or is carried by control plane information.

In some embodiments, the delay information and/or the time information is dynamic or semi-static.

In some embodiments, the second operation is performed unconditionally.

In some embodiments, the second operation is performed in a case where at least one of the first event, the first condition, the second event, or the second condition is met.

In some embodiments, the bi-directional QoS requirement information is obtained based on pre-configuration information of an application layer or a network device, or the bi-directional QOS requirement information is determined or identified based on the pre-configuration information of the application layer or the network device. Optionally, the pre-configuration information further includes at least one of: identification information of the bi-directional QoS, or an entity or an object or resource information corresponding to the bi-directional QoS. Optionally, the pre-configuration information is transmitted via a Uu interface or a Pc5 interface.

In some embodiments, the bi-directional QoS requirement information is determined or identified based on interactive information between the receiving end and the transmitting end, or the bi-directional QoS requirement information is obtained based on the interactive information between the receiving end and the transmitting end. That is, the bi-directional QoS requirement information may be determined by negotiation between the receiving end and the transmitting end. Optionally, the interaction information further includes at least one of: identification information of the bi-directional QoS, or an entity or an object or resource information corresponding to the bi-directional QoS.

In some embodiments, the bi-directional QoS requirement information is obtained by the transmitting end from a higher layer of a bi-directional QoS entity. That is, the transmitting end obtains the bi-directional QoS requirement information from the higher layer. Optionally, at least one of the following may also be obtained: identification information of the bi-directional QoS, or an entity or an object or resource information corresponding to the bi-directional QoS. Optionally, obtaining from the high layer is an inter-layer interaction.

In some embodiments, the bi-directional QoS requirement information is obtained by the transmitting end from a high layer or NAS layer or application layer of the transmitting end entity. That is, the transmitting end obtains bi-directional QoS requirement information from the higher layer or NAS layer or application layer. Optionally, at least one of the following may also be obtained: identification information of the bi-directional QoS, or an entity or an object or resource information corresponding to the bi-directional QoS. Optionally, obtaining from the high layer is an inter-layer interaction.

In some embodiments, the bi-directional QoS requirement information is determined, obtained or identified based on information in a data packet received by the transmitting end from a higher layer. Optionally, the information in the data packet from the higher layer is carried in a header or load of the data packet. Optionally, the information in the data packet from the higher layer further includes at least one of: identification information of the bi-directional QoS, or an entity or an object or resource information corresponding to the bi-directional QoS.

In some embodiments, the identification information of the bi-directional QoS is used for identifying an object that performs the bi-directional QoS, or the identification information of the bi-directional QoS is used for indicating that an object having the identification information of the bi-directional QoS performs the bi-directional QoS.

In some embodiments, the entity or the object or the resource information corresponding to the bi-directional QoS includes at least one of: an identifier (ID) of the transmitting end, a group ID to which the transmitting end belongs, an ID of the receiving end, a group ID to which the receiving end belongs, a group ID of the bi-directional QoS, an entity ID of the bi-directional QoS, a terminal ID set of the bi-directional QoS, an entity set of the bi-directional QoS, an object set of the bi-directional QoS, a QoS flow ID, a logical channel (LCH) ID, a logical channel group (LCG) ID, an application ID, a PDU session ID, a DRB ID, a physical channel ID, or a transmission resource set.

In some embodiments, the term “information in the data packet” described in the embodiments of the present application is carried in the header or load of the data packet. The term “auxiliary information” described in the embodiments of the present application is carried by RRC signaling or MAC CE.

In some embodiments, the bi-directional QoS requirement information is information of QoS flow granularity, or the bi-directional QoS requirement information is information of data packet granularity, or the bi-directional QoS requirement information is information of MAC PDU granularity corresponding to the data packet, or the bi-directional QoS requirement information is information of data burst granularity, or the bi-directional QoS requirement information is information of RB granularity, or the bi-directional QoS requirement information is information of LCH granularity, or the bi-directional QoS requirement information is information of LCG granularity, or the bi-directional QOS requirement information is information of PDU session granularity, or the bi-directional QoS requirement information is terminal-specific information, or the bi-directional QoS requirement information is specific information between the transmitting end and the receiving end, or the bi-directional QoS requirement information is application-specific information, or the bi-directional QoS requirement information is terminal group-specific information.

In some embodiments, the second operation is an operation of data packet granularity, or the second operation is an operation of MAC PDU granularity corresponding to the data packet, or the second operation is an operation of QoS flow granularity, or the second operation is an operation of RB granularity, or the second operation is an operation of data burst granularity, or the second operation is an operation of LCH granularity, or the second operation is an operation of LCG granularity, or the second operation is an operation of PDU session granularity, or the second operation is a terminal-specific operation, or the second operation is a specific operation between the transmitting end and the receiving end, or the second operation is an application-specific operation, or the second operation is a terminal group-specific operation.

In some embodiments, the second operation is non-real-time, and/or the second operation is performed periodically, and/or the second operation is performed within a fourth duration or at a second moment, and/or the second operation is performed in a case where a trigger condition is met, and/or the second operation is performed in a case where a trigger event is met, and/or the second operation is real-time.

In some embodiments, consistent second operations are performed on different objects, or different second operations are performed on different objects.

In some embodiments, the trigger or trigger condition of the second operation is different for different objects, or the trigger or trigger condition of the second operation is the same for different objects.

In some embodiments, in a case where the second operation is the operation of data packet granularity or the operation of MAC PDU granularity corresponding to the data packet, or in a case where the second operation is for the data burst, or in a case where the second operation is for the data packet or the MAC PDU corresponding to the data packet, the second operation is real-time, and/or the second operation is performed in a case where a trigger condition is met, and/or the second operation is performed in a case where a trigger event is met.

For example, in a case where the second operation is the operation of data packet granularity or the operation of MAC PDU granularity corresponding to the data packet, the second operation is real-time, and/or the second operation is performed in a case where a trigger condition is met, and/or the second operation is performed in a case where a trigger event is met.

For another example, in a case where the second operation is for the data burst, the second operation is real-time, and/or the second operation is performed in a case where a trigger condition is met, and/or the second operation is performed in a case where a trigger event is met.

For yet another example, in a case where the second operation is for the data packet or the MAC PDU corresponding to the data packet, the second operation is real-time, and/or the second operation is performed in a case where a trigger condition is met, and/or the second operation is performed in a case where a trigger event is met.

In some embodiments, in a case where the second operation is the operation of QoS flow granularity or the operation of RB granularity or the operation of LCH granularity or LCG granularity or the operation of PDU session granularity, or in a case where the second operation is the terminal-specific operation, or in a case where the second operation is the specific operation between the transmitting end and the receiving end, or in a case where the second operation is the application-specific operation, or in a case where the second operation is the terminal group-specific operation, the second operation is non-real-time, and/or the second operation is performed periodically, and/or the second operation is performed within a fourth duration or at a second moment, and/or the second operation is performed in a case where a trigger condition is met, and/or the second operation is performed in a case where a trigger event is met.

For example, in a case where the second operation is the operation of QoS flow granularity or the operation of RB granularity or the operation of LCH granularity or LCG granularity or the operation of PDU session granularity, the second operation is non-real-time, and/or the second operation is performed periodically, and/or the second operation is performed within a fourth duration or at a second moment, and/or the second operation is performed in a case where a trigger condition is met, and/or the second operation is performed in a case where a trigger event is met.

For another example, in a case where the second operation is the terminal-specific operation, the second operation is non-real-time, and/or the second operation is performed periodically, and/or the second operation is performed within a fourth duration or at a second moment, and/or the second operation is performed in a case where a trigger condition is met, and/or the second operation is performed in a case where a trigger event is met.

For yet another example, in a case where the second operation is the specific operation between the transmitting end and the receiving end, the second operation is non-real-time, and/or the second operation is performed periodically, and/or the second operation is performed within a fourth duration or at a second moment, and/or the second operation is performed in a case where a trigger condition is met, and/or the second operation is performed in a case where a trigger event is met.

For yet another example, in a case where the second operation is the application-specific operation, the second operation is non-real-time, and/or the second operation is performed periodically, and/or the second operation is performed within a fourth duration or at a second moment, and/or the second operation is performed in a case where a trigger condition is met, and/or the second operation is performed in a case where a trigger event is met.

For yet another example, in a case where the second operation is the terminal group-specific operation, the second operation is non-real-time, and/or the second operation is performed periodically, and/or the second operation is performed within a fourth duration or at a second moment, and/or the second operation is performed in a case where a trigger condition is met, and/or the second operation is performed in a case where a trigger event is met.

In some embodiments, the fourth duration is agreed by the protocol, or the fourth duration is configured by the network, or the fourth duration is determined by one of the receiving end and the transmitting end, or the fourth duration is determined by negotiation between the receiving end and the transmitting end.

In some embodiments, the second moment is agreed by the protocol, or the second moment is configured by the network, or the second moment is determined by one of the receiving end and the transmitting end, or the second moment is determined by negotiation between the receiving end and the transmitting end.

In some embodiments, the second operation meets at least one of:
the second operation being an operation that is performed unconditionally;
the second operation being a periodic operation;
the second operation being an event-triggered operation;
the second operation being a condition-triggered operation; or
the second operation being performed within the fourth duration or at the second moment.

For example, the second operation is an operation that is performed periodically within the fourth duration.

For another example, the second operation is an operation triggered by an event within the fourth duration.

For yet another example, the second operation is an operation triggered by a condition within the fourth duration.

For yet another example, the second operation is an operation triggered by an event at the second moment.

For yet another example, the second operation is an operation triggered by a condition at the second moment.

In some embodiments, in a case where the second operation is performed periodically (i.e., the second operation is a periodic operation), periodic information performed by the second operation is agreed by the protocol, or the periodic information performed by the second operation is configured by the network, or the periodic information performed by the second operation is determined by the receiving end, or the periodic information performed by the second operation is determined by the transmitting end, or the periodic information performed by the second operation is determined by negotiation between the receiving end and the transmitting end.

In some embodiments, in a case where the second operation is performed within the fourth duration or at the second moment, the fourth duration or the second moment is agreed by the protocol, or the fourth duration or the second moment is configured by the network, or the fourth duration or the second moment is determined by the receiving end, or the fourth duration or the second moment is determined by the transmitting end, or the fourth duration or the second moment is determined by negotiation between the receiving end and the transmitting end.

In some embodiments, in a case where the second operation is performed when a condition is triggered (i.e., the second operation is a condition-triggered operation), the condition that triggers performing the first operation includes at least one of: a data packet arriving, a data packet being transmitted, MAC PDU being received, the data packet being received, data packet being successfully decoded, data of the reverse link being received, feedback information of the reverse link being received, the auxiliary information being transmitted, the auxiliary information being received, the delay information being received, the time information being received, data of the reverse link being transmitted, the feedback of the reverse link being transmitted, the PDB of the reverse link changing, delay of the reverse link changing, at least one of bi-directional QoS requirement information changing or changing to be greater than or equal to a first threshold, a unidirectional transmission delay of the data packet changing or changing to be greater than or equal to a second threshold, a round-trip delay changing or changing to be greater than or equal to a third threshold, a remaining delay changing or changing to be greater than or equal to a fourth threshold, RTT being reset or the being reset to be greater than or equal to a fifth threshold, the PDB of the reverse link changing or changing to be greater than or equal to a sixth threshold, the PDB of the reverse link being received, the PSDB of the reverse link changing or changing to be greater than or equal to a seventh threshold, the PSDB of the reverse link being received, information of the reverse link being received, trigger information of the auxiliary information being received, or the auxiliary information changing to be greater than or equal to an eighth threshold.

In some embodiments, in a case where the second operation is the event-triggered operation (i.e., the second operation is performed in a case where a trigger event is met), the event that triggers performing the second operation includes at least one of: a data packet arriving, a data packet being transmitted, MAC PDU reception, the data packet being received, the data packet being successfully decoded, data of reverse link being received, feedback information of the reverse link being received, the auxiliary information being transmitted, the auxiliary information being received, the delay information being received, the time information being received, data of the reverse link being transmitted, the feedback of the reverse link being transmitted, the PDB of the reverse link changing, reverse link delay changing, at least one of bi-directional QoS requirement information changing, a unidirectional transmission delay of the data packet changing, a round-trip delay changing, a remaining delay changing, RTT being reset, the PDB of the reverse link being received, change in the PSDB of the reverse link, the PSDB of the reverse link being received, information of the reverse link being received, trigger information of the auxiliary information being received, the auxiliary information changing, the trigger information of the auxiliary information being received for the first-time, the auxiliary information being transmitted for the first-time, or feedback information being transmitted for the first-time.

In some embodiments, the second operation is agreed by the protocol, or the second operation is pre-configured or dynamically indicated by the network, or the second operation is performed based on network configuration or pre-configuration, or the second operation is performed based on an indication from the peer end, or the second operation is performed by the receiving end based on the information from the transmitting end, or the second operation is determined by negotiation between the receiving end and the transmitting end.

Therefore, in the embodiments of the present application, in a case of having bi-directional QoS requirement, the transmitting end may perform the second operation according to bi-directional QoS requirement information, thereby ensuring the bi-directional QoS requirement to improve the quality of sidelink communication.

The technical solutions of the present application will be described in detail below through some embodiments.

### Embodiment 1

In a case where the transmitting end and the receiving end have bi-directional QoS requirement, the transmitting end and/or the receiving end performs related operations according to the bi-directional QoS requirement. The related operations include at least one of: reporting, determining a remaining delay, adjusting a PDB of a reverse link, or adjusting a selected resource/resource set.

Optionally, the related operations may be periodic and/or event-triggered. The event-triggered may be a data packet arriving, the data packet being transmitted, a unidirectional transmission delay of the data packet changing, a round-trip delay changing, a remaining delay changing, and RTT being reset.

Optionally, the bi-directional QoS requirement may be at a QoS flow level or a packet level.

Optionally, the bi-directional QoS requirement includes bi-directional QoS parameters. Optionally, the bi-directional QoS includes the RTT.

Optionally, a peer end or multiple parties for the bi-directional QoS requirement may be explicitly indicated (for example, two parties pre-configured by an application layer or a network, or a group pre-configured by the application layer or the network, or the transmitting end and the receiving end are interactive), or may be implicitly determined (for example, whether configured QoS parameters include bi-directional QoS parameters, or whether bi-directional QoS is enabled).

### Embodiment 2 (Behaviors of the Receiving End Supporting Bi-Directional QoS Transmission)

1. The receiving end, such as UE, obtains or identifies the bi-directional QoS requirement information. Optional, at least one of the following contents is included.
a) Alt a: the bi-directional QoS requirement information is determined, obtained or identified based on pre-configuration information of an application layer or a base station. Optionally, the pre-configuration information may be transmitted via a Uu or PC5 interface.
i. Optionally, the pre-configuration information includes a bi-directional QoS requirement, such as a RTT parameter.
ii. Optionally, the pre-configuration information includes endpoint identifiers, such as a group ID, a peer end identifier, a QoS flow identifier, an LCH identifier, and an application identifier, corresponding to the bi-directional QoS requirement.
iii. Optionally, whether related behaviors of enable bi-directional QoS requirement are carried in the pre-configuration information or other information.
b) Alt b: the bi-directional QoS requirement information is determined, obtained or identified based on interactive information between UEs. Optionally, the interaction information between the UEs may be transmitted via a PC5 interface.
i. Optionally, the interaction information includes bi-directional QoS requirement, such as a RTT parameter.
ii. Optionally, the interaction information includes a bi-directional requirement indication.
iii. Optionally, the interaction information includes identification information, such as endpoint identifiers (e.g., a group ID, a peer end identifier, a QoS flow identifier, an LCH identifier, and an application identifier).
iv. Optionally, whether related behaviors of enable bi-directional QoS requirement are carried in the pre-configuration information or other information.
c) Alt c: the bi-directional QoS requirement information is determined, obtained or identified based on information in the data packet received by the receiving end from the a peer end. For example, the data packet carries bi-directional QoS parameters, such as RTT. For example, the data packet carries delay information and/or time information. For example, the data packet carries an enable bi-directional indication, or carries identifiers (e.g., a group ID, a transmitting end identifier, a QoS flow identifier, an LCH identifier, and an application identifier) of the peer end for the bi-directional QoS.
i. Optionally, the information in the data packet is carried in a header or load.
d) Alt c: the bi-directional QoS requirement information is determined, obtained or identified based on auxiliary information received by the receiving end from the peer end. For example, the auxiliary information transmitted by the transmitting end to the receiving end carries relevant information of the bi-directional QoS, such as an enable bi-directional indication, or delay information, or time information, or bi-directional QoS parameters (e.g., RTT).
i. Optionally, the auxiliary information is carried in the RRC message or MAC CE.
2. The receiving end performs related operations according to the bi-directional QoS requirement. The related operations include at least one of the following: determining/adjusting the PDB of the reverse link, determining the remaining delay, or adjusting the selected resource/resource set.
a) Alt1: the receiving end obtains the delay information from the transmitting end. The delay may be a recommended PDB of the reverse link, a remaining delay or a used/occupied delay.
i. The receiving end determines the remaining delay and/or determines/adjusts the PDB of the reverse link (reverse link PDB) and/or adjusts the selected resource/resource set according to the bi-directional QoS requirement, such as the RTT parameter and/or the delay information.

Optionally, adjusting the selected resource/resource set may include: determining the transmitted resource/resource set, and/or adjusting a selection priority for the resources when selecting available resources.

Optionally, the behavior is for QoS flow, or for a corresponding packet.

Optionally, the behavior is a real-time behavior, or a non-real-time behavior (e.g., a periodic behavior, a behavior within a certain time period, a behavior under certain conditions (for example, the remaining delay and/or the reverse link PDB changing exceeding a certain threshold, or the remaining delay and/or the reverse link PDB being less than a first threshold, or the remaining delay and/or the reverse link PDB being greater than a second threshold).
ii. For example, SL-Receiver of forward direction monitors the latency (e.g., via report on latency) to adapt the PDB of reverse link (e.g., via prioritization, resource selection and etc).
b) Alt2: the receiving end obtains time information from the transmitting end, and the time information may be: a time when the data packet arrives at the transmitting end, a time when the data packet is buffered at the transmitting end, a time when the data packet is generated, or timestamp information of the data packet.
i. The receiving end determines the remaining delay and/or adjusts the reverse link PDB, and/or adjusts the selected resources/resource set according to the bi-directional QoS requirement (e.g., RTT parameters), and the time information.

Optionally, adjusting the selected resource/resource set may include: determining the transmitted resource/resource set, and/or adjusting a selection priority for the resource when selecting available resources.

Optionally, the behavior is for QoS flow, or for a corresponding packet.

Optionally, the behavior is a real-time behavior, or a non-real-time behavior (e.g., a periodic behavior, a behavior within a certain time period, a behavior under certain conditions (for example, the remaining delay and/or the reverse link PDB changing exceeding a certain threshold, or the remaining delay and/or the reverse link PDB being less than a first threshold, or the remaining delay and/or the reverse link PDB being greater than a second threshold).
ii. For example, SL-Receiver of forward direction monitors the latency (e.g., via report on latency) to adapt the PDB of reverse link (e.g., via prioritization, resource selection and etc).
c) Optionally, the delay information and/or time information from the transmitting end is carried in the data PDU of the AS, and may also be carried in the auxiliary information.
d) Optionally, the determining/calculating of the remaining delay and/or reserve link PDB is determined/calculated by the transmitting end or the receiving end, and may be predefined, preconfigured, or indicated by the network, or negotiated by both parties.
c) In a case of transmitting at the peer end, the UE at the transmitting end directly communicates with the UE at the receiving end via relay or SL.

Beneficial effect: information of the receiving end is determined, and bi-directional QOS requirement is ensured from the receiving perspective.

### Embodiment 3 (Behaviors of the Transmitting End Supporting Bi-Directional QoS Transmission)

1. The transmitting end, such as UE, obtains or identifies the bi-directional QoS requirement information. Optional, at least one of the following contents is included.
a) Alt a: the bi-directional QoS requirement information is determined, obtained or identified based on pre-configuration information of an application layer or a base station. Optionally, the pre-configuration information may be transmitted via a Uu or PC5 interface.
i. Optionally, the pre-configuration information includes bi-directional QoS requirement, such as a RTT parameter.
ii. Optionally, the pre-configuration information includes endpoint identifiers, such as a group ID, a peer end identifier, a QoS flow identifier, an LCH identifier, and an application identifier, corresponding to the bi-directional QoS requirement.
iii. Optionally, whether related behaviors of enable bi-directional QoS requirements are carried in the pre-configuration information or other information.
b) Alt b: the bi-directional QoS requirement information is determined, obtained or identified based on interactive information between UEs. Optionally, the interaction information between the UEs may be transmitted via a PC5 interface.
i. Optionally, the interaction information includes bi-directional QoS requirement, such as a RTT parameter.
ii. Optionally, the interaction information includes a bi-directional demand indication.
iii. Optionally, the interaction information includes identification information, such as endpoint identifiers (e.g., a group ID, a peer end identifier, a QoS flow identifier, an LCH identifier, and an application identifier.
iv. Optionally, whether related behaviors of enable bi-directional QoS requirement are carried in the pre-configuration information or other information.
c) Alt c: the bi-directional QoS requirement information is determined, obtained or identified based on information in the data packet received by the transmitting end from the higher layer. For example, the data packet carries an enable bi-directional indication, or carries peer end identifiers (e.g., a group ID, a peer end identifier, a QoS flow identifier, an LCH identifier, and an application identifier) for the bi-directional QoS.
i. Optionally, the information in the data packet is carried in a header or load.
2. The transmitting end performs related operations according to the bi-directional QoS requirement. The related operations include at least one of: reporting, determining the remaining delay, or determining a recommended reserve link PDB.
a) Alt1: the reporting is reporting delay information. The delay may be the recommended PDB of the reverse link, the remaining delay, and the used/occupied delay.
i. Optionally, in a case where the reporting is reporting delay information, the delay information may be real-time information or may be a statistical delay (for example, within a period of time).
ii. Optionally, the remaining delay may be determined by the transmitting end. Optionally, the determining/calculating the remaining delay by the transmitting end or the receiving end, or whether the transmitting end determining or calculating the recommended PDB of the reserve link may be predefined, preconfigured, or indicated by the network, or negotiated by both parties.
b) Alt2: the reporting is reporting time information. The time information may be: a time when the data packet arrives at the transmitting end, a time when the data packet is buffered at the transmitting end, a time when the data packet is generated, or timestamp information of the data packet.
i. Optionally, the reporting is real-time information.
ii. Optionally, Alt2 and alt1 may be used in combination.
c) The reporting may be periodic or event-triggered.
d) Optionally, determining the remaining delay may be periodic or event-triggered.
c) Optionally, determining the recommended reserve link PDB may be periodic or event-triggered.
f) The reporting is that the transmitting end exchanges the delay information and/or time information to the receiving end (a peer end). The delay information and/or time information may be carried in the data PDU of the AS, or may be carried in auxiliary information to the peer end.
g) In a case where transmission occurs at the peer end, the UE at the transmitting end directly communicates with the UE at the receiving end via relay or SL.

Beneficial effect: information of the transmitting end is determined, and bi-directional QoS requirement is ensured from the transmitting perspective.

The method embodiments of the present application are described in detail above with reference to FIGS. 4 to 6. The apparatus embodiments of the present application will be described in detail below with reference to FIGS. 7 to 11. It should be understood that the apparatus embodiments and the method embodiments correspond to each other, and similar description may refer to the method embodiments.

FIG. 7 shows a schematic block diagram of a receiving end 400 according to the embodiments of the present application. As shown in FIG. 7, the receiving end 400 includes:
a processing unit 410 configured to perform a first operation according to bi-directional quality of service (QOS) requirement information on a sidelink;
where the first operation includes at least one of: determining a packet delay budget (PDB) of a reverse link, adjusting the PDB of the reverse link, determining a PDU set delay budget (PSDB) of the reverse link, adjusting the PSDB of the reverse link, determining a remaining delay, determining a remaining delay of the reverse link, deleting packets, recommending a PSDB of a forward link, recommending a PDB of the forward link, adjusting a selected resource, adjusting a selected resource set, selecting a transmission resource, selecting a transmission resource set, recommending an optional resource for a transmitting end, recommending an optional resource set for the transmitting end, triggering feedback, performing feedback, obtaining or determining time information, obtaining or determining delay information, or obtaining or determining auxiliary information.

In some embodiments, the processing unit 410 is configured to:
perform the first operation according to the bi-directional QoS requirement information, and at least one of the auxiliary information, the delay information, or the time information obtained from the transmitting end for assisting in performing the first operation.

In some embodiments, the delay information includes at least one of: bi-directional transmission delays, bi-directional PDBs, a PDB of the reverse link recommended by the transmitting end, the remaining delay determined by the transmitting end, bi-directional PSDBs, a PSDB of the reverse link recommended by the transmitting end, or a delay used/occupied by the transmitting end.

In some embodiments, the delay information corresponds to a real-time delay, or the delay information corresponds to a statistical delay within a first duration, or the delay information is a delay corresponding to a first time, or the delay information is a delay corresponding to a first event and/or a first condition.

In some embodiments, the first duration is agreed by a protocol, or the first duration is configured by a network, or the first duration is determined by one of the transmitting end or the receiving end, or the first duration is determined by negotiation between the receiving end and the transmitting end.

In some embodiments, the first time is an absolute time, or the first time is a relative time, or the first time is associated with a first system frame number (SFN), or the first time is associated with a first slot, or the first time is associated with a first time domain symbol, or the first time is associated with a first reference time.

In some embodiments, the first event includes at least one of: a data packet arriving, a data packet being transmitted, media access control protocol data unit (MAC PDU) being received, the data packet being received, the data packet being successfully decoded, data of reverse link being received, feedback information of the reverse link being received, auxiliary information being transmitted, the auxiliary information being received, the delay information being received, the time information being received, the data of the reverse link being transmitted, the feedback information of the reverse link being transmitted, the PDB of the reverse link changing, reverse link delay changing, at least one of bi-directional QoS requirement information changing, a unidirectional transmission delay of the data packet changing, a round-trip delay changing, remaining delay changing, a round-trip transmission time (RTT) being reset, the PDB of the reverse link being received, the PSDB of the reverse link changing, the PSDB of the reverse link changing, reverse link information being received, trigger information of the auxiliary information being received, the auxiliary information changing, the trigger information of the auxiliary information being received for the first time, the auxiliary information being transmitted for the first time, or the feedback information being transmitted for the first time; or
the first condition includes at least one of: a data packet arriving, a data packet transmission, MAC PDU being received, the data packet being received, the data packet being successfully decoded, data of reverse link being received, feedback information of reverse link being received, the auxiliary information being transmitted, the auxiliary information being received, the delay information being received, the time information being received, the data of the reverse link being transmitted, feedback information of the reverse link being transmitted, the PDB of the reverse link changing, reverse link delay changing, at least one of bi-directional QoS requirement information changing or changing to be greater than or equal to a first threshold, a unidirectional transmission delay of the data packet changing or changing to be greater than or equal to a second threshold, a round-trip delay changing or changing to be greater than or equal to a third threshold, remaining delay changing or changing to be greater than or equal to a fourth threshold, RTT being reset or reset to be greater than or equal to a fifth threshold, the PDB of the reverse link changing or changing to be greater than or equal to a sixth threshold, the PDB of the reverse link being received, the PSDB of the reverse link changing or changing to be greater than or equal to a seventh threshold, the PSDB of the reverse link being received, information of reverse link being received, trigger information of the auxiliary information being received, or the auxiliary information changing to be greater than or equal to an eighth threshold.

In some embodiments, a delay corresponding to the delay information is an absolute time, or the delay corresponding to the delay information is a relative time, or the delay corresponding to the delay information is a number of SFNs and/or an interval between the SFNs, or the delay corresponding to the delay information is a number of symbols and/or an interval between the symbols, or the delay corresponding to the delay information is a number of slots and/or an interval between the slots.

In some embodiments, the time information includes at least one of: a time when the data packet arrives at the transmitting end, a time when the data packet is buffered at the transmitting end, a time when the data packet is generated, a time when the data packet is transmitted, a time when the data packet is transmitted to the receiving end, a time when the MAC PDU containing the data packet is generated, or timestamp information of the data packet.

In some embodiments, the time information corresponds to real time, or the time information corresponds to a statistical time within a second duration, or the time information is a time corresponding to a second time, or the time information is a time corresponding to a second event and/or a second condition.

In some embodiments, the second duration is agreed by the protocol, or the second duration is configured by the network, or the second duration is determined by one of the transmitting end or the receiving end, or the second duration is determined by negotiation between the receiving end and the transmitting end.

In some embodiments, the second duration is an absolute time, or the second duration is a relative time, or the second duration is associated with a second SFN, or the second duration is associated with a second slot, or the second duration is associated with a second duration domain symbol, or the second duration is associated with a second reference time.

In some embodiments, the second event includes at least one of: a data packet arriving, a data packet being transmitted, MAC PDU being received, the data packet being received, the data packet being successfully decoded, data of the reverse link being received, feedback information of the reverse link being received, the auxiliary information being transmitted, the auxiliary information being received, the delay information being received, the time information being received, data of the reverse link being transmitted, the feedback information of the reverse link being transmitted, the PDB of the reverse link changing, reverse link delay changing, at least one of bi-directional QoS requirement information changing, a unidirectional transmission delay of the data packet changing, a round-trip delay changing, a remaining delay changing, RTT being reset, the PDB of the reverse link being received, the PSDB of the reverse link changing, the PSDB of the reverse link being received, information of the reverse link being received, trigger information of the auxiliary information being received, the auxiliary information changing, the trigger information of the auxiliary information being received for the first time, the auxiliary information being transmitted for the first time, or feedback information being transmitted for the first time; or
the second condition includes at least one of: a data packet arriving, a data packet being transmitted, MAC PDU being received, the data packet being received, the data packet being successfully decoded, data of the reverse link being received, feedback information of reverse link being received, the auxiliary information being transmitted, the auxiliary information being received, the delay information being received, the time information being received, the data of the reverse link being transmitted, the feedback information of the reverse link being transmitted, the PDB of the reverse link changing, reverse link delay changing, at least one of bi-directional QOS requirement information changing or changing to be greater than or equal to a first threshold, a unidirectional transmission delay of the data packet changing or changing to be greater than or equal to a second threshold, a round-trip delay changing or changing to be greater than or equal to a third threshold, a remaining delay changing or changing to be greater than or equal to a fourth threshold, RTT being reset or reset to be greater than or equal to a fifth threshold, the PDB of the reverse link changing or changing to be greater than or equal to a sixth threshold, the PDB of the reverse link being received, the PSDB of the reverse link changing or changing to be greater than or equal to a seventh threshold, the PSDB of the reverse link being received, information of the reverse link being received, trigger information of the auxiliary information being received, or the auxiliary information changing to be greater than or equal to an eighth threshold.

In some embodiments, the delay information and/or the time information is carried by information in the data packet, or the delay information and/or the time information is carried by a data protocol data unit (PDU) of an access layer (AS), or the delay information and/or the time information is carried by the auxiliary information used for assisting in performing the first operation, or the delay information and/or the time information is carried by terminal auxiliary information from the transmitting end to the receiving end.

In some embodiments, the bi-directional QoS requirement information includes at least one of: RTT, or indication information for enabling or disabling the bi-directional QoS requirement.

In some embodiments, the bi-directional QoS requirement information is obtained based on pre-configuration information of an application layer or a network device, or the bi-directional QOS requirement information is determined or identified based on the pre-configuration information of the application layer or the network device.

In some embodiments, the pre-configuration information further includes at least one of: identification information of the bi-directional QoS, or an entity or an object or resource information corresponding to the bi-directional QoS.

In some embodiments, the pre-configuration information is transmitted via a Uu interface or a Pc5 interface.

In some embodiments, the bi-directional QoS requirement information is determined or identified based on interactive information between the receiving end and the transmitting end, or the bi-directional QoS requirement information is obtained based on the interactive information between the receiving end and the transmitting end.

In some embodiments, the interaction information further includes at least one of: identification information of the bi-directional QoS, or an entity or an object or resource information corresponding to the bi-directional QoS.

In some embodiments, the bi-directional QoS requirement information is obtained from the transmitting end.

In some embodiments, the bi-directional QoS requirement information is carried by first information;
where the first information is one of: information in the data packet received by the receiving end from the transmitting end, terminal auxiliary information from the transmitting end to the receiving end, radio resource control (RRC) information from the transmitting end to the receiving end, media access control layer control unit (MAC CE) information from the transmitting end to the receiving end, physical layer information from the transmitting end to the receiving end, or the auxiliary information used for assisting in performing the first operation.

In some embodiments, the first information further includes at least one of: identification information of the bi-directional QoS, or an entity or an object or resource information corresponding to the bi-directional QoS.

In some embodiments, the information in the data packet is carried in a header or load of the data packet.

In some embodiments, the auxiliary information is carried by a RRC signaling or a MAC CE.

In some embodiments, the identification information of the bi-directional QoS is used for identifying an object that performs the bi-directional QoS, or the identification information of the bi-directional QoS is used for indicating that an object having the identification information of the bi-directional QoS performs the bi-directional QoS; and/or
the entity or the object or the resource information corresponding to the bi-directional QoS includes at least one of: an identifier of the transmitting end, a group identifier to which the transmitting end belongs, an identifier of the receiving end, a group identifier to which the receiving end belongs, a group identifier of the bi-directional QoS, an entity identifier of the bi-directional QoS, a terminal identifier set of the bi-directional QoS, an entity set of the bi-directional QoS, an object set of the bi-directional QoS, a QoS flow identifier, a logical channel (LCH) identifier, a logical channel group (LCG) identifier, an application identifier, a PDU session identifier, a DRB identifier, a physical channel identifier, or a transmission resource set.

In some embodiments, adjusting the selected resource includes at least one of: determining a resource for transmission, determining an available resource in a candidate resource set, determining a priority of the resource in the candidate resource set, or adjusting a priority of the available resource in selection; and/or
adjusting the selected resource set includes at least one of: determining a resource set for transmission, determining an available resource set in a candidate resource set, or adjusting a priority of the available resource set in selection.

In some embodiments, recommending the optional resource for the transmitting end includes at least one of: recommending the optional resource for data transmitted from the transmitting end to the receiving end, recommending the optional resource for the data packet transmitted from the transmitting end to the receiving end, recommending the optional resource for information transmitted from the transmitting end to the receiving end, or recommending the transmission resource for the data packet or information transmitted from the transmitting end to the receiving end; and/or
recommending the optional resource set for the transmitting end includes at least one of: recommending the optional resource set for data transmitted from the transmitting end to the receiving end, recommending the optional resource set for data packets transmitted from the transmitting end to the receiving end, recommending the optional resource set for information transmitted from transmitting end to the receiving end, or recommending the transmission resource set for the data packets or information transmitted from the transmitting end to the receiving end.

In some embodiments, triggering feedback includes at least one of: triggering the transmitting end transmitting the auxiliary information, or triggering the transmitting end transmitting the time information and/or the delay information; and/or
performing feedback includes at least one of: transmitting the feedback information to the transmitting end; triggering the receiving end transmitting the feedback information to the transmitting end; feeding back the time information and/or the delay information of the reverse link; feeding back the resource information selected by the receiving end; transmitting or feeding back, to the transmitting end, the resource or information recommended by the receiving end for use by the transmitting end; transmitting, to the transmitting end, the information requested by the receiving end for the transmitting end to transmit or trigger; transmitting or feeding back, to the transmitting end, the information requested by the receiving end for the transmitting end to transmit or trigger; transmitting or feeding back, to a peer end, the resource or information recommended by the receiving end for use by the transmitting end; transmitting, to the peer end, information requested by the receiving end for the transmitting end to transmit or trigger; or feeding back, to the peer end, the information requested by the receiving end for the transmitting end to transmit or trigger.

In some embodiments, in a case where the first operation includes performing feedback or the triggering feedback at least, the first operation is used for the transmitting end to perform at least one of:
determining the PDB of the forward link, adjusting the PDB of the forward link, determining the PSDB of the forward link, adjusting the PSDB of the forward link, determining the unidirectional transmission delay, adjusting the selected resource, adjusting the selected resource set, selecting the transmission resource, selecting the transmission resource set, recommending the optional resource set for the receiving end, recommending the optional resource for the receiving end, transmitting the auxiliary information, transmitting the time information and/or the delay information, or deleting packets.

In some embodiments, the bi-directional QoS requirement information is information of QoS flow granularity, or the bi-directional QoS requirement information is information of data packet granularity, or the bi-directional QoS requirement information is information of MAC PDU granularity corresponding to the data packet, or the bi-directional QoS requirement information is information of data burst granularity, or the bi-directional QoS requirement information is information of RB granularity, or the bi-directional QoS requirement information is information of LCH granularity, or the bi-directional QoS requirement information is information of LCG granularity, or the bi-directional QoS requirement information is information of PDU session granularity, or the bi-directional QoS requirement information is terminal-specific information, or the bi-directional QoS requirement information is specific information between the transmitting end and the receiving end, or the bi-directional QoS requirement information is application-specific information, or the bi-directional QoS requirement information is terminal group-specific information.

In some embodiments, the first operation is an operation of data packet granularity, or the first operation is an operation of MAC PDU granularity corresponding to the data packet, or the first operation is an operation of QoS flow granularity, or the first operation is an operation of RB granularity, or the first operation is an operation of data burst granularity, or the first operation is an operation of LCH granularity, or the first operation is an operation of LCG granularity, or the first operation is an operation of PDU session granularity, or the first operation is a terminal-specific operation, or the first operation is a specific operation between the transmitting end and the receiving end, or the first operation is an application-specific operation, or the first operation is a terminal group-specific operation.

In some embodiments, in a case where the first operation is the operation of data packet granularity or the operation of MAC PDU granularity corresponding to the data packet, or in a case where the first operation is for the data burst, or in a case where the first operation is for the data packet or the MAC PDU corresponding to the data packet, the first operation is real-time, and/or the first operation is performed in a case where a trigger condition is met, and/or the first operation is performed in a case where a trigger event is met.

In some embodiments, in a case where the first operation is the operation of QoS flow granularity or the operation of RB granularity or the operation of LCH granularity or LCG granularity or the operation of PDU session granularity, or in a case where the first operation is the terminal-specific operation, or in a case where the first operation is the specific operation between the transmitting end and the receiving end, or in a case where the first operation is the application-specific operation, or in a case where the first operation is the terminal group-specific operation, the first operation is non-real-time, and/or the first operation is performed periodically, and/or the first operation is performed within a third duration or at a first moment, and/or the first performed in a case where a trigger event is met.

In some embodiments, the first operation meets at least one of:
the first operation being an operation that is performed unconditionally;
the first operation being a periodic operation;
the first operation being an event-triggered operation;
the first operation being a condition-triggered operation; or
the first operation being performed within the third duration or at the first moment.

In some embodiments, in a case where the first operation is performed periodically, periodic information performed by the first operation is agreed by the protocol, or the periodic information performed by the first operation is configured by the network, or the periodic information performed by the first operation is determined by the receiving end, or the periodic information performed by the first operation is determined by the transmitting end, or the periodic information performed by the first operation is determined by negotiation between the receiving end and the transmitting end.

In some embodiments, in a case where the first operation is performed within the third duration or at the first moment, the third duration or the first moment is agreed by the protocol, or the third duration or the first moment is configured by the network, or the third duration or the first moment is determined by the receiving end, or the third duration or the first moment is determined by the transmitting end, or the third duration or the first moment is determined by negotiation between the receiving end and the transmitting end.

In some embodiments, in a case where the first operation is performed in a case where a trigger condition is met, the condition that triggers performing the first operation includes at least one of: a data packet arriving, the data packet being transmitted, MAC PDU being received, the data packet being received, the data packet being successfully decoded, data of the reverse link being received, feedback information of the reverse link being received, the auxiliary information being transmitted, the auxiliary information being received, the delay information being received, the time information being received, the data of the reverse link being transmitted, the feedback of the reverse link being transmitted, the PDB of the reverse link changing, reverse link delay changing, at least one of bi-directional QoS requirement information changing or changing to be greater than or equal to a first threshold, a unidirectional transmission delay of the data packet changing or changing to be greater than or equal to a second threshold, a round-trip delay changing or changing to be greater than or equal to a third threshold, a remaining delay changing or changing to be greater than or equal to a fourth threshold, RTT being reset or reset to be greater than or equal to a fifth threshold, the PDB of the reverse link changing or changing to be greater than or equal to a sixth threshold, the PDB of the reverse link being received, the PSDB of the reverse link changing or changing to be greater than or equal to a seventh threshold, the PSDB of the reverse link being received, information of the reverse link being received, trigger information of the auxiliary information being received, or the auxiliary information changing to be greater than or equal to an eighth threshold.

In some embodiments, in a case where the first operation is the event-triggered operation, the event that triggers performing the first operation includes at least one of: a data packet arriving, a data packet being transmitted, MAC PDU reception, the data packet being received, the data packet being successfully decoded, data of the reverse link being received, feedback information of the reverse link being received, the auxiliary information being transmitted, the auxiliary information being received, the delay information being received, the time information being received, the data of the reverse link being transmitted, the feedback of the reverse link being transmitted, the PDB of the reverse link changing, reverse link delay changing, at least one of bi-directional QoS requirement information changing, a unidirectional transmission delay of the data packet changing, a round-trip delay changing, a remaining delay changing, RTT being reset, the PDB of the reverse link being received, the PSDB of the reverse link changing, the PSDB of the reverse link being received, information of reverse link being received, trigger information of the auxiliary information being received, the auxiliary information changing, the trigger information of the auxiliary information being received for the first time, the auxiliary information being transmitted for the first time, or feedback information being transmitted for the first time.

In some embodiments, the first operation is agreed by the protocol, or the first operation is pre-configured or dynamically indicated by the network, or the first operation is performed based on network configuration or pre-configuration, or the first operation is performed based on an indication from the peer end, or the first operation is performed by the receiving end based on the information from the transmitting end, or the first operation is determined by negotiation between the receiving end and the transmitting end.

In some embodiments, the receiving end and the transmitting end communicate directly via the sidelink, or the receiving end and the transmitting end communicate via a relay link.

In some embodiments, the above communication unit may be a communication interface or a transceiver, or an input/output interface of a communication chip or a system on chip. The above processing unit may be one or more processors.

It should be understood that the receiving end 400 according to the embodiments of the present application may correspond to the receiving end 400 in the method embodiments of the present application, and the above and other operations and/or functions of various units in the receiving end 400 are respectively for implementing the corresponding processes of the receiving end in the method 200 shown in FIG. 4, which will not be repeated here for brevity.

FIG. 8 shows a schematic block diagram of a transmitting end 500 according to the embodiments of the present application. As shown in FIG. 8, the transmitting end 500 includes:
a processing unit 510 configured to perform a second operation according to bi-directional quality of service (QOS) requirement information on a sidelink;
the second operation includes at least one of: transmitting delay information to a receiving end, transmitting time information to the receiving end, transmitting auxiliary information to the receiving end, modifying or determining a forward transmission delay, adjusting or determining a PDU set delay budget (PSDB) of a forward link, adjusting or determining a packet delay budget (PDB) of the forward link, determining the delay information, determining the time information, determining the auxiliary information, determining a remaining delay, deleting packets, determining a recommended PSDB of a reverse link, determining a recommended PDB of the reverse link, adjusting a selected resource set, selecting a transmission resource, selecting a transmission resource set, recommending the optional resource for the receiving end, or recommending the optional resource set for the receiving end.

In some embodiments, the delay information includes at least one of: bi-directional transmission delays, bi-directional PDBs, the PDB of the reverse link recommended by the transmitting end, bi-directional PSDBs, the PSDB of the reverse link recommended by the transmitting end, the remaining delay determined by the transmitting end, or a delay used/occupied by the transmitting end.

In some embodiments, the delay information corresponds to a real-time delay, or the delay information corresponds to a statistical delay within a first duration, or the delay information is a delay corresponding to a first time, or the delay information is a delay corresponding to a first event and/or a first condition.

In some embodiments, the first duration is agreed by a protocol, or the first duration is determined by one of the transmitting end or the receiving end, or the first duration is configured by a network, or the first duration is determined by negotiation between the receiving end and the transmitting end.

In some embodiments, the first time is an absolute time, or the first time is a relative time, or the first time is associated with a first system frame number (SFN), or the first time is associated with a first slot, or the first time is associated with a first time domain symbol, or the first time is associated with a first reference time.

In some embodiments, the first event includes at least one of: a data packet arriving, a data packet transmission, a media access control protocol data unit (MAC PDU) being received, a data packet being received, a data packet being successfully decoded, data of the reverse link being received, feedback information of the reverse link being received, the auxiliary information being transmitted, the auxiliary information being received, the delay information being received, the time information being received, the data of the reverse link being transmitted, the feedback information of the reverse link being transmitted, the PDB of the reverse link changing, a delay of the reverse link changing, at least one of bi-directional QoS requirement information changing, a unidirectional transmission delay of the data packet changing, a round-trip delay changing, a remaining delay changing, a round-trip transmission time (RTT) being reset, the PDB of the reverse link being received, the PSDB of the reverse link changing, the PSDB of the reverse link being received, information of the reverse link being received, trigger information of the auxiliary information being received, the auxiliary information changing, the trigger information of the auxiliary information being received for the first time, the auxiliary information being transmitted for the first time, or feedback information being transmitted for the first time; or
the first condition includes at least one of: a data packet arriving, the data packet transmission, a MAC PDU being received, the data packet being received, the data packet being successfully decoded, data of the reverse link being received, feedback information of reverse link being received, the auxiliary information being transmitted, the auxiliary information being received, the delay information being received, the time information being received, data of the reverse link being transmitted, feedback information of the reverse link being transmitted, the PDB of the reverse link changing, a delay of the reverse link changing, at least one of bi-directional QoS requirement information changing or changing to be greater than or equal to a first threshold, a unidirectional transmission delay of the data packet changing or changing to be greater than or equal to a second threshold, a round-trip delay changing or changing to be greater than or equal to a third threshold, a remaining delay changing or changing to be greater than or equal to a fourth threshold, RTT being reset or resetting to be greater than or equal to a fifth threshold, the PDB of the reverse link changing or changing to be greater than or equal to a sixth threshold, the PDB of the reverse link being received, the PSDB of the reverse link changing or changing to be greater than or equal to a seventh threshold, the PSDB of the reverse link being received, information of the reverse link being received, trigger information of the auxiliary information being received, or the auxiliary information changing to be greater than or equal to an eighth threshold.

In some embodiments, a delay corresponding to the delay information is an absolute time, or the delay corresponding to the delay information is a relative time, or the delay corresponding to the delay information is a number of SFNs and/or an interval between the SFNs, or the delay corresponding to the delay information is a number of symbols and/or an interval between the symbols, or the delay corresponding to the delay information is a number of slots and/or an interval between the slots.

In some embodiments, the time information includes at least one of: a time when the data packet arrives at the transmitting end, a time when the data packet is buffered at the transmitting end, a time when the data packet is generated, a time when the data packet is transmitted, a time when the data packet is transmitted to the receiving end, a time when the MAC PDU containing the data packet is generated, or timestamp information of the data packet.

In some embodiments, the time information corresponds to real time, or the time information corresponds to a statistical time within a second duration, or the time information is a time corresponding to a second time, or the time information is a time corresponding to a second event or a second condition.

In some embodiments, the second duration is agreed by the protocol, or the second duration is determined by one of the transmitting end or the receiving end, or the second duration is configured by the network, or the second duration is determined by negotiation between the receiving end and the transmitting end.

In some embodiments, the second duration is an absolute time, or the second duration is a relative time, or the second duration is associated with a second SFN, or the second duration is associated with a second slot, or the second duration is associated with a second duration domain symbol, or the second duration is associated with a second reference time.

In some embodiments, the second event includes at least one of: a data packet arriving, the data packet being transmitted, MAC PDU being received, the data packet being received, data packet being successfully decoded, data of the reverse link being transmitted, data of the reverse link being received, feedback information of the reverse link being received, the auxiliary information being transmitted, the auxiliary information being received, the delay information being received, the time information being received, the feedback information of the reverse link being transmitted, the PDB of the reverse link changing, a delay of the reverse link changing, at least one of bi-directional QoS requirement information changing, a unidirectional transmission delay of the data packet changing, a round-trip delay changing, a remaining delay changing, RTT being reset, the PDB of the reverse link being received, the PSDB of the reverse link changing, the PSDB of the reverse link being received, information of the reverse link being received, trigger information of the auxiliary information being received, the auxiliary information changing, the trigger information of the auxiliary information being received for the first time, the auxiliary information being transmitted for the first time, or feedback information being transmitted for the first time; or
the second condition includes at least one of: a data packet arriving, the data packet being transmitted, MAC PDU being received, the data packet being received, the data packet being successfully decoded, data of the reverse link being received, feedback information of reverse link being received, the auxiliary information being transmitted, the auxiliary information being received, the delay information being received, the time information being received, the data of the reverse link being transmitted, the feedback information of the reverse link being transmitted, the PDB of the reverse link changing, a delay of the reverse link changing, at least one of bi-directional QoS requirement information changing or changing to be greater than or equal to a first threshold, a unidirectional transmission delay of the data packet changing or changing to be greater than or equal to a second threshold, a round-trip delay changing or changing to be greater than or equal to a third threshold, a remaining delay changing or changing to be greater than or equal to a fourth threshold, RTT being reset or reset to be greater than or equal to a fifth threshold, the PDB of the reverse link changing or changing to be greater than or equal to a sixth threshold, the PDB of the reverse link being received, the PSDB of the reverse link changing or changing to be greater than or equal to a seventh threshold, the PSDB of the reverse link being received, information of the reverse link being received, trigger information of the auxiliary information being received, or the auxiliary information changing to be greater than or equal to an eighth threshold.

In some embodiments, the delay information and/or the time information is carried by information in the data packet, or the delay information and/or the time information is carried by a data protocol data unit (PDU) of an access layer (AS), or the delay information and/or the time information is carried by the auxiliary information used for assisting in performing the second operation, or the delay information and/or the time information is carried by terminal auxiliary information from the transmitting end to the receiving end.

In some embodiments, the bi-directional QoS requirement information includes at least one of: RTT, or indication information for enabling or disabling the bi-directional QoS requirement.

In some embodiments, the bi-directional QoS requirement information is obtained based on pre-configuration information of an application layer or a network device, or the bi-directional QoS requirement information is determined or identified based on the pre-configuration information of the application layer or the network device.

In some embodiments, the pre-configuration information further includes at least one of: identification information of the bi-directional QoS, or an entity or an object or resource information corresponding to the bi-directional QoS.

In some embodiments, the pre-configuration information is transmitted via a Uu interface or a Pc5 interface.

In some embodiments, the bi-directional QoS requirement information is determined or identified based on interactive information between the receiving end and the transmitting end, or the bi-directional QoS requirement information is obtained based on the interactive information between the receiving end and the transmitting end.

In some embodiments, the interaction information further includes at least one of: identification information of the bi-directional QoS, or an entity or an object or resource information corresponding to the bi-directional QoS.

In some embodiments, the bi-directional QoS requirement information is determined, obtained or identified based on information in a data packet received by the transmitting end from a higher layer.

In some embodiments, the information in the data packet from the higher layer is carried in a header or load of the data packet.

In some embodiments, the information in the data packet from the higher layer further includes at least one of: identification information of the bi-directional QoS, or an entity or an object or resource information corresponding to the bi-directional QoS.

In some embodiments, the identification information of the bi-directional QoS is used for identifying an object that performs the bi-directional QoS, or the identification information of the bi-directional QoS is used for indicating that an object having the identification information of the bi-directional QoS performs the bi-directional QoS; and/or
the entity or the object or the resource information corresponding to the bi-directional QoS includes at least one of: an identifier of the transmitting end, a group identifier to which the transmitting end belongs, an identifier of the receiving end, a group identifier to which the receiving end belongs, a group identifier of the bi-directional QoS, an entity identifier of the bi-directional QoS, a terminal identifier set of the bi-directional QoS, an entity set of the bi-directional QoS, an object set of the bi-directional QoS, a QoS flow identifier, a logical channel (LCH) identifier, a logical channel group (LCG) identifier, an application identifier, a PDU session identifier, a DRB identifier, a physical channel identifier, or a transmission resource set.

In some embodiments, adjusting the selected resource includes at least one of: determining a resource for transmission, determining an available resource in a candidate resource set, determining a priority of the resource in the candidate resource set, or adjusting a priority of the available resource in selection; and/or
adjusting the selected resource set includes at least one of: determining a resource set for transmission, determining an available resource set in a candidate resource set, or adjusting a priority of the available resource set in selection.

In some embodiments, recommending the optional resource for the receiving end includes at least one of: recommending the optional resource for data transmitted from the receiving end to the transmitting end, recommending the optional resource for the data packet transmitted from the receiving end to the transmitting end, recommending the optional resource for information transmitted from the transmitting end to the receiving end, and recommending the transmission resource for the data packet or information transmitted from the receiving end to the transmitting end; and/or
recommending the optional resource set for the receiving end includes at least one of: recommending the optional resource set for data transmitted from the receiving end to the transmitting end, recommending the optional resource set for data packets transmitted from the receiving end to the transmitting end, recommending the optional resource set for information transmitted from the transmitting end to the receiving end, and recommending the transmission resource set for the data packet or information transmitted from the receiving end to the transmitting end.

In some embodiments, the bi-directional QoS requirement information is information of QoS flow granularity, or the bi-directional QoS requirement information is information of data packet granularity, or the bi-directional QOS requirement information is information of MAC PDU granularity corresponding to the data packet, or the bi-directional QoS requirement information is information of data burst granularity, or the bi-directional QoS requirement information is information of resource block (RB) granularity, or the bi-directional QoS requirement information is information of LCH granularity, or the bi-directional QoS requirement information is information of LCG granularity, or the bi-directional QoS requirement information is information of PDU session granularity, or the bi-directional QoS requirement information is terminal-specific information, or the bi-directional QoS requirement information is specific information between the transmitting end and the receiving end, or the bi-directional QoS requirement information is application-specific information, or the bi-directional QoS requirement information is terminal group-specific information.

In some embodiments, the second operation is an operation of data packet granularity, or the second operation is an operation of MAC PDU granularity corresponding to the data packet, or the second operation is an operation of QoS flow granularity, or the second operation is an operation of RB granularity, or the second operation is an operation of data burst granularity, or the second operation is an operation of LCH granularity, or the second operation is an operation of LCG granularity, or the second operation is an operation of PDU session granularity, or the second operation is a terminal-specific operation, or the second operation is a specific operation between the transmitting end and the receiving end, or the second operation is an application-specific operation, or the second operation is a terminal group-specific operation.

In some embodiments, in a case where the second operation is the operation of data packet granularity or the operation of MAC PDU granularity corresponding to the data packet, or in a case where the second operation is for the data burst, or in a case where the second operation is for the data packet or the MAC PDU corresponding to the data packet, the second operation is real-time, and/or the second operation is performed in a case where a trigger condition is met, and/or the second operation is performed in a case where a trigger event is met.

In some embodiments, in a case where the second operation is the operation of QoS flow granularity or the operation of RB granularity or the operation of LCH granularity or LCG granularity or the operation of PDU session granularity, or in a case where the second operation is the terminal-specific operation, or in a case where the second operation is the specific operation between the transmitting end and the receiving end, or in a case where the second operation is the application-specific operation, or in a case where the second operation is the terminal group-specific operation, the second operation is non-real-time, and/or the second operation is performed periodically, and/or the second operation is performed within a fourth duration or at a second moment, and/or the second operation is performed in a case where a trigger condition is met, and/or the second operation is performed in a case where a trigger event is met.

In some embodiments, the second operation meets at least one of:
the second operation being an operation that is performed unconditionally;
the second operation being a periodic operation;
the second operation being an event-triggered operation;
the second operation being a condition-triggered operation; or
the second operation being performed within the fourth duration or at the second moment.

In some embodiments, in a case where the second operation is performed periodically, periodic information performed by the second operation is agreed by the protocol, or the periodic information performed by the second operation is configured by the network, or the periodic information performed by the second operation is determined by the receiving end, or the periodic information performed by the second operation is determined by the transmitting end, or the periodic information performed by the second operation is determined by negotiation between the receiving end and the transmitting end.

In some embodiments, in a case where the second operation is performed within the fourth duration or at the second moment, the fourth duration or the second moment is agreed by the protocol, or the fourth duration or the second moment is configured by the network, or the fourth duration or the second moment is determined by the receiving end, or the fourth duration or the second moment is determined by the transmitting end, or the fourth duration or the second moment is determined by negotiation between the receiving end and the transmitting end.

In some embodiments, in a case where the second operation is performed in a case where the second operation is the condition-triggered operation, the condition that triggers performing the first operation includes at least one of: a data packet arriving, a data packet being transmitted, a MAC PDU being received, the data packet being received, the data packet being successfully decoded, data of the reverse link being received, feedback information of reverse link being received, the auxiliary information being transmitted, the auxiliary information being received, the delay information being received, the time information being received, data of the reverse link being transmitted, the feedback of the reverse link being transmitted, the PDB of the reverse link changing, a delay of the reverse link changing, at least one of bi-directional QoS requirement information changing or changing to be greater than or equal to a first threshold, a unidirectional transmission delay of the data packet changing or changing to be greater than or equal to a second threshold, a round-trip delay changing or changing to be greater than or equal to a third threshold, a remaining delay changing or changing to be greater than or equal to a fourth threshold, RTT being reset or reset to be change greater than or equal to a fifth threshold, the PDB of the reverse link changing or changing to be greater than or equal to a sixth threshold, the PDB of the reverse link being received, the PSDB of the reverse link changing or changing to be greater than or equal to a seventh threshold, the PSDB of the reverse link being received, information of the reverse link being received, trigger information of the auxiliary information being received, or the auxiliary information changing to be greater than or equal to an eighth threshold.

In some embodiments, in a case where the second operation is the event-triggered operation, the event that triggers performing the second operation includes at least one of: a data packet arriving, the data packet being transmitted, MAC PDU being received, the data packet being received, the data packet being successfully decoded, data of the reverse link being received, feedback information of the reverse link being received, the auxiliary information being transmitted, the auxiliary information being received, the delay information being received, the time information being received, data of the reverse link being transmitted, the feedback of the reverse link being transmitted, the PDB of the reverse link changing, a delay of the reverse link changing, at least one of bi-directional QoS requirement information changing, a unidirectional transmission delay of the data packet changing, a round-trip delay changing, a remaining delay changing, RTT being reset, the PDB of the reverse link being received, the PSDB of the reverse link changing, the PSDB of the reverse link being received, information of the reverse link being received, trigger information of the auxiliary information being received, the auxiliary information changing, the trigger information of the auxiliary information being received for the first time, the auxiliary information being transmitted for the first time, or feedback information being transmitted for the first time.

In some embodiments, the second operation is agreed by the protocol, or the second operation is pre-configured or dynamically indicated by the network, or the second operation is performed based on network configuration or pre-configuration, or the second operation is performed based on an indication from a peer end, or the second operation is performed by the receiving end based on the information from the transmitting end, or the second operation is determined by negotiation between the receiving end and the transmitting end.

In some embodiments, the receiving end and the transmitting end communicate directly via the sidelink, or the receiving end and the transmitting end communicate via a relay link.

In some embodiments, the above communication unit may be a communication interface or a transceiver, or an input/output interface of a communication chip or a system on chip. The above processing unit may be one or more processors.

It should be understood that the transmitting end 500 according to the embodiment of the present application may correspond to the transmitting end in the method embodiments of the present application, and the above and other operations and/or functions of various units in the transmitting end 500 are respectively for implementing the corresponding process of the transmitting end in the method 300 shown in FIG. 6, which will not be repeated here for the sake of brevity.

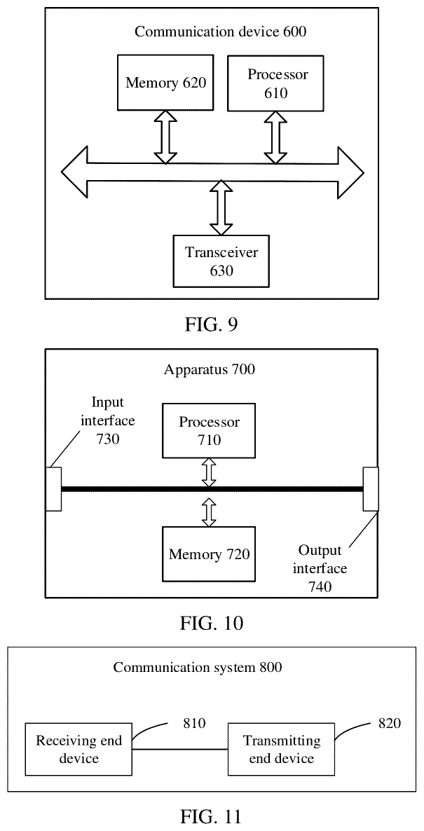

FIG. 9 is a schematic structural diagram of a communication device 600 provided in the embodiments of the present application. The communication device 600 shown in FIG. 9 includes a processor 610, and the processor 610 may call a computer program from a memory and run the computer program, so as to implement the methods in the embodiments of the present application.

In some embodiments, as shown in FIG. 9, the communication device 600 may further include a memory 620. The processor 610 may call a computer program from the memory 620 and run the computer program, so as to implement the methods in the embodiments of the present application.

The memory 620 may be a separate device independent of the processor 610, or may be integrated into the processor 610.

In some embodiments, as shown in FIG. 9, the communication device 600 may further include a transceiver 630, and the processor 610 may control the transceiver 630 to communicate with other devices, and optionally, to transmit information or data to other devices, or receive information or data transmitted by other devices.

The transceiver 630 may include a transmitter and a receiver. The transceiver 630 may further include antenna(s), and the number of antennas may be one or more.

In some embodiments, the processor 610 may implement the functions of the processing unit in the receiving end, or the processor 610 may implement the functions of the processing unit in the transmitting end, which will not be repeated here for the sake of brevity.

In some embodiments, the transceiver 630 may implement the functions of the communication unit in the receiving end, which will not be repeated here for the sake of brevity.

In some embodiments, the transceiver 630 may implement the functions of the communication unit in the transmitting end, which will not be repeated here for the sake of brevity.

In some embodiments, the communication device 600 may be the transmitting end in the embodiments of the present application, and the communication device 600 may implement the corresponding processes implemented by the transmitting end in the various methods in the embodiments of the present application, which will not be repeated here for the sake of brevity.

In some embodiments, the communication device 600 may be the receiving end of the embodiments of the present application, and the communication device 600 may implement the corresponding processes implemented by the receiving end in the various methods in the embodiment of the present application, which will not be repeated here for the sake of brevity.

FIG. 10 is a schematic structural diagram of an apparatus of the embodiments of the present application. The apparatus 700 shown in FIG. 10 includes a processor 710, and the processor 710 may call a computer program from a memory and run the computer program to implement the methods in the embodiments of the present application.

In some embodiments, as shown in FIG. 10, the apparatus 700 may further include a memory 720. The processor 710 may call a computer program from the memory 720 and run the computer program to implement the methods in the embodiments of the present application.

The memory 720 may be a separate device independent of the processor 710, or may be integrated into the processor 710.

In some embodiments, the processor 710 may implement the functions of the processing unit in the receiving end, or the processor 710 may implement the functions of the processing unit in the transmitting end, which will not be repeated here for the sake of brevity.

In some embodiments, the apparatus 700 may further include an input interface 730. The processor 710 may control the input interface 730 to communicate with other devices or chips, and optionally, to obtain information or data transmitted by other devices or chips. Optionally, the processor 710 may be located inside or outside the chip.

In some embodiments, the input interface 730 may implement the functions of the communication unit in the receiving end, or the input interface 730 may implement the functions of the communication unit in the transmitting end.

In some embodiments, the apparatus 700 may further include an output interface 740. The processor 710 may control the output interface 740 to communicate with other devices or chips, and optionally, to output information or data to other devices or chips. Optionally, the processor 710 may be located inside or outside the chip.

In some embodiments, the output interface 740 may implement the functions of the communication unit in the receiving end, or the output interface 740 may implement the functions of the communication unit in the transmitting end.

In some embodiments, the apparatus may be applied to the transmitting end in the embodiments of the present application, and the apparatus may implement the corresponding processes implemented by the transmitting end in the various methods in the embodiments of the present application, which will not be repeated here for the sake of brevity.

In some embodiments, the apparatus may be applied to the receiving end in the embodiments of the present application, and the apparatus may implement the corresponding processes implemented by the receiving end in the various methods in the embodiments of the present application, which will not be repeated here for the sake of brevity.

In some embodiments, the apparatus mentioned in the embodiments of the present disclosure may also be a chip, for example, may be a system level chip, a system chip, a chip system, or a system-on-chip chip, etc.

FIG. 11 is a schematic block diagram of a communication system 800 provided in the embodiments of the present application. As shown in FIG. 11, the communication system 800 includes a receiving end device 810 and a transmitting end device 820.

The receiving end device 810 may be used to implement the corresponding functions implemented by the receiving end in the above methods, and the transmitting end device 820 may be used to implement the corresponding functions implemented by the transmitting end in the above methods, which will not be repeated here for the sake of brevity.

It should be understood that the processor of the embodiments of the present disclosure may be an integrated circuit chip with signal processing capabilities. In the implementation process, various steps of the above method embodiments may be completed by an integrated logic circuit of hardware in a processor or an instruction in software form. The above-mentioned processor may be a general purpose processor, a digital signal processor (DSP), an application specific integrated circuit (ASIC), a field programmable gate array (FPGA) or other programmable logic devices, a discrete gate or transistor logic device, or a discrete hardware component. The various methods, steps and logic diagrams disclosed in the embodiments of the present application may be implemented or executed. The general purpose processor may be a microprocessor, or the processor may be any conventional processor or the like. The steps of the methods disclosed in combination with the embodiments of the present application may be directly embodied as being performed and completed by a hardware decoding processor, or by using a combination of hardware and software modules in the decoding processor. The software module may be located in the mature storage medium in the art such as the random memory, the flash memory, the read-only memory, the programmable read-only memory or electrically erasable programmable memory, the register. The storage medium is located in the memory, and the processor reads the information in the memory and completes the steps of the above methods in combination with its hardware.

It may be understood that the memory in the embodiments of the present application may be a volatile memory or a non-volatile memory, or may include both volatile and non-volatile memories. Here, the non-volatile memory may be a read-only memory (ROM), a programmable ROM (PROM), an erasable PROM (EPROM), an electrically EPROM (EEPROM) or a flash memory. The volatile memory may be a random access memory (RAM), which is used as an external cache. Through illustrative, rather than limiting illustration, many forms of RAMs are available, for example, a static random access memory (SRAM), a dynamic random access memory (DRAM), a synchronous DRAM (SDRAM), a double data rate SDRAM (DDR SDRAM), an enhanced SDRAM (ESDRAM), a synchlink DRAM (SLDRAM) and a direct rambus RAM (DR RAM). It should be noted that the memory of the system and the methods described herein is intended to include, but not limited to, these and any other suitable types of memories.

It should be understood that the above memory is exemplary but not limiting illustration, for example, the memory in embodiments of the present disclosure may also be a static RAM (SRAM), a dynamic RAM (DRAM), a synchronous DRAM (SDRAM), a double data rate SDRAM (DDR SDRAM), an enhanced SDRAM (ESDRAM), a synch link DRAM (SLDRAM), and a direct rambus RAM (DR RAM), etc. That is, the memory in the embodiments of the present disclosure is intended to include, but not limited to, these and any other suitable types of memories.

The embodiments of the present application further provide a non-transitory computer readable storage medium for storing a computer program.

In some embodiments, the non-transitory computer readable storage medium may be applied to the transmitting end in the embodiments of the present application, and the computer program enables a computer to perform the corresponding processes implemented by the transmitting end in various methods of the embodiments of the present application, which will not be repeated here for the sake of brevity.

In some embodiments, the non-transitory computer readable storage medium may be applied to the receiving end in the embodiments of the present application, and the computer program enables a computer to perform the corresponding processes implemented by the receiving end in various methods of the embodiments of the present application, which will not be repeated here for the sake of brevity.

The embodiments of the present application further provide a computer program product including computer program instructions.

In some embodiments, the computer program product may be applied to the transmitting end in the embodiments of the present application, and the computer program instructions enable a computer to perform the corresponding processes implemented by the transmitting end in the various methods in the embodiments of the present disclosure, which will not be repeated here for the sake of brevity.

In some embodiments, the computer program product may be applied to the receiving end in the embodiments of the present disclosure, and the computer program instructions enable a computer to perform the corresponding processes implemented by the receiving end in the various methods in the embodiments of the present disclosure, which will not be repeated here for the sake of brevity.

The embodiments of the present application further provide a computer program.

In some embodiments, the computer program may be applied to transmitting end in the embodiments of the present application, the computer program, when executed on a computer, enables the computer to perform the corresponding processes implemented by the transmitting end in various methods in the embodiments of the present application, which will not be repeated here for the sake of brevity.

In some embodiments, the computer program may be applied to receiving end in the embodiments of the present application, the computer program, when executed on a computer, enables the computer to perform the corresponding processes implemented by the receiving end in various methods of the embodiments of the present application, which will not be repeated here for the sake of brevity.

Those ordinary skilled in the art may realize that, units and algorithm steps of the examples described in combination with the embodiments disclosed herein can be implemented in electronic hardware or in a combination of computer software and electronic hardware. Whether these functions are performed by way of hardware or software depends on a specific application and a design constraint of the technical solution. A skilled person may use different methods for each specific application, to implement the described functions, but such implementation should not be considered beyond the scope of the present disclosure.

Those skilled in the art can clearly understand that for the convenience and simplicity of description, the working processes of the systems, devices and units described above may refer to the corresponding processes in the above method embodiments, and details will not be repeated here.

In the several embodiments provided by the application, it should be understood that, the disclosed systems, apparatus, and method may be implemented in other ways. For example, the apparatus embodiments described above are only schematic, for example, division of the units is only division of logical functions, and there may be other division methods in an actual implementation, for example, a plurality of units or components may be combined or integrated into another system, or some features may be ignored or not performed. In addition, the coupling or direct coupling or communicative connection between each other as shown or discussed may be indirect coupling or communicative connection of apparatus or units via some interfaces, which may be electrical, mechanical, or in other forms.

The units shown as separate components may be or may not be physically separated, and the components shown as units may be or may not be physical units; that is, they may be located in one place, or may be distributed onto a plurality of network units. A part or all of the units may be selected according to actual needs, to implement the purpose of the schemes of the embodiments.

In addition, the various functional units in the various embodiments of the present application may be integrated into one processing unit, or the various units may exist physically separately, or two or more units may be integrated into one unit.

If the described functions are implemented in a form of a software functional unit and sold or used as an independent product, they may be stored in one non-transitory computer readable storage medium. Based on this understanding, the technical solution of the present application essentially, or a part of the technical solution that contributes to the related art, or a part of the technical solution, may be embodied in a form of a software product, and the computer software product is stored in a non-transitory storage medium, and includes a plurality of instructions to cause a computer device (which may be a personal computer, a server, or a network device, etc.) to perform all or some of steps of the methods described in the various embodiments of the present application. Moreover, the non-transitory storage medium mentioned above includes a USB flash drive (U disk), a mobile hard disk, a read-only memory (ROM), a random access memory (RAM), a diskette, or an optical disk, and various mediums that may store program codes.

The above content is only some implementations of the present disclosure, but the protection scope of the present disclosure is not limited thereto, and any skill familiar with this technical field may easily think of changes or substitutions within the technical scope disclosed in the present disclosure, which should be all covered within the protection scope of the present disclosure. Therefore, the protection scope of the present disclosure should be subject to the protection scope of the claims.

What is claimed is:

1. A wireless communication method, comprising:
performing, by a receiving end, a first operation according to bi-directional quality of service (QoS) requirement information on a sidelink;
wherein the first operation comprises at least one of: determining a packet delay budget (PDB) of a reverse link, adjusting the PDB of the reverse link, determining a PDU set delay budget (PSDB) of the reverse link, adjusting the PSDB of the reverse link, determining a remaining delay, determining a remaining delay of the reverse link, deleting packets, recommending a PSDB of a forward link, recommending a PDB of the forward link, adjusting a selected resource, adjusting a selected resource set, selecting a transmission resource, selecting a transmission resource set, recommending an optional resource for a transmitting end, recommending an optional resource set for the transmitting end, triggering feedback, performing feedback, obtaining or determining time information, obtaining or determining delay information, or obtaining or determining auxiliary information.

2. The method according to claim 1, wherein
performing, by the receiving end, the first operation according to the bi-directional QoS requirement information on the sidelink comprises:
performing, by the receiving end, the first operation according to the bi-directional QoS requirement information, and at least one of the auxiliary information, the delay information, or the time information obtained from the transmitting end for assisting in performing the first operation.

3. The method according to claim 2, wherein
the delay information comprises at least one of: bi-directional transmission delays, bi-directional PDBs, a PDB of the reverse link recommended by the transmitting end, the remaining delay determined by the transmitting end, bi-directional PSDBs, a PSDB of the reverse link recommended by the transmitting end, or a delay used/occupied by the transmitting end.

4. The method according to claim 3, wherein
the delay information corresponds to a real-time delay, or the delay information corresponds to a statistical delay within a first duration, or the delay information is a delay corresponding to a first time, or the delay information is a delay corresponding to a first event and/or a first condition.

5. The method according to claim 2, wherein a delay corresponding to the delay information is an absolute time, or the delay corresponding to the delay information is a relative time, or the delay corresponding to the delay information is a number of SFNs and/or an interval between the SFNs, or the delay corresponding to the delay information is a number of symbols and/or an interval between the symbols, or the delay corresponding to the delay information is a number of slots and/or an interval between the slots.

6. The method according to claim 2, wherein
the time information comprises at least one of: a time when the data packet arrives at the transmitting end, a time when the data packet is buffered at the transmitting end, a time when the data packet is generated, a time when the data packet is transmitted, a time when the data packet is transmitted to the receiving end, a time when the MAC PDU containing the data packet is generated, or timestamp information of the data packet.

7. The method according to claim 1, wherein
the bi-directional QoS requirement information comprises at least one of: RTT, or indication information for enabling or disabling the bi-directional QoS requirement.

8. The method according to claim 1, wherein
the bi-directional QoS requirement information is obtained based on pre-configuration information of an application layer or a network device, or the bi-directional QoS requirement information is determined or identified based on the pre-configuration information of the application layer or the network device.

9. The method according to claim 1, wherein
the bi-directional QoS requirement information is determined or identified based on interactive information between the receiving end and the transmitting end, or the bi-directional QoS requirement information is obtained based on the interactive information between the receiving end and the transmitting end.

10. The method according to claim 1, wherein
the bi-directional QoS requirement information is obtained from the transmitting end.

11. The method according to claim 1, wherein
recommending the optional resource for the transmitting end comprises at least one of: recommending the optional resource for data transmitted from the transmitting end to the receiving end, recommending the optional resource for a data packet transmitted from the transmitting end to the receiving end, recommending the optional resource for information transmitted from the transmitting end to the receiving end, or recommending the transmission resource for the data packet or information transmitted from the transmitting end to the receiving end; and/or
recommending the optional resource set for the transmitting end comprises at least one of: recommending the optional resource set for data transmitted from the transmitting end to the receiving end, recommending the optional resource set for a data packet transmitted from the transmitting end to the receiving end, recommending the optional resource set for information transmitted from transmitting end to the receiving end, or recommending the transmission resource set for the data packet or information transmitted from the transmitting end to the receiving end.

12. The method according to claim 1, wherein
triggering feedback comprises at least one of: triggering the transmitting end transmitting the auxiliary information, or triggering the transmitting end transmitting the time information and/or the delay information; and/or
performing feedback comprises at least one of: transmitting the feedback information to the transmitting end; triggering the receiving end transmitting the feedback information to the transmitting end; feeding back the time information and/or the delay information of the reverse link; feeding back resource information selected by the receiving end; transmitting or feeding back, to the transmitting end, a resource or information recommended by the receiving end for use by the transmitting end; transmitting, to the transmitting end, information requested by the receiving end for the transmitting end to transmit or trigger; transmitting or feeding back, to the transmitting end, the information requested by the receiving end for the transmitting end to transmit or trigger; transmitting or feeding back to a peer end a resource or information recommended by the receiving end for use by the transmitting end; transmitting, to the peer end, information requested by the receiving end for the transmitting end to transmit or trigger; or feeding back to the peer end the information requested by the receiving end for the transmitting end to transmit or trigger.

13. The method according to claim 1, wherein
the bi-directional QoS requirement information is information of QoS flow granularity, or the bi-directional QoS requirement information is information of data packet granularity, or the bi-directional QoS requirement information is information of MAC PDU granularity corresponding to the data packet, or the bi-directional QoS requirement information is information of data burst granularity, or the bi-directional QoS requirement information is information of resource block (RB) granularity, or the bi-directional QoS requirement information is information of LCH granularity, or the bi-directional QoS requirement information is information of LCG granularity, or the bi-directional QoS requirement information is information of PDU session granularity, or the bi-directional QoS requirement information is terminal-specific information, or the bi-directional QoS requirement information is specific information between the transmitting end and the receiving end, or the bi-directional QoS requirement information is application-specific information, or the bi-directional QoS requirement information is terminal group-specific information.

14. The method according to claim 1, wherein
the first operation is an operation of data packet granularity, or the first operation is an operation of MAC PDU granularity corresponding to a data packet, or the first operation is an operation of QoS flow granularity, or the first operation is an operation of RB granularity, or the first operation is an operation of data burst granularity, or the first operation is an operation of LCH granularity, or the first operation is an operation of LCG granularity, or the first operation is an operation of PDU session granularity, or the first operation is a terminal-specific operation, or the first operation is a specific operation between the transmitting end and the receiving end, or the first operation is an application-specific operation, or the first operation is a terminal group-specific operation.

15. The method according to claim 1, wherein the first operation meets at least one of:
the first operation being an operation that is performed unconditionally;
the first operation being a periodic operation;
the first operation being an event-triggered operation;
the first operation being a condition-triggered operation; or
the first operation being performed within a third duration or at a first moment.

16. A wireless communication method, comprising:
performing, by a transmitting end, a second operation according to bi-directional quality of service (QOS) requirement information on a sidelink;
wherein the second operation comprises at least one of: transmitting delay information to a receiving end, transmitting time information to the receiving end, transmitting auxiliary information to the receiving end, modifying or determining a forward transmission delay, adjusting or determining a PDU set delay budget (PSDB) of a forward link, adjusting or determining a packet delay budget (PDB) of the forward link, determining the delay information, determining the time information, determining the auxiliary information, determining a remaining delay, deleting packets, determining a recommended PSDB of a reverse link, determining a recommended PDB of the reverse link, adjusting a selected resource set, selecting a transmission resource, selecting a transmission resource set, recommending an optional resource for the receiving end, or recommending an optional resource set for the receiving end.

17. The method according to claim 16, wherein
the delay information comprises at least one of: bi-directional transmission delays, bi-directional PDBs, the PDB of the reverse link recommended by the transmitting end, bi-directional PSDBs, the PSDB of the reverse link recommended by the transmitting end, the remaining delay determined by the transmitting end, or a delay used/occupied by the transmitting end.

18. The method according to claim 17, wherein
the delay information corresponds to a real-time delay, or the delay information corresponds to a statistical delay within a first duration, or the delay information is a delay corresponding to a first time, or the delay information is a delay corresponding to a first event and/or a first condition.

19. The method according to claim 16, wherein
the bi-directional QoS requirement information is obtained based on pre-configuration information of an application layer or a network device, or the bi-directional QoS requirement information is determined or identified based on the pre-configuration information of the application layer or the network device;
or
the bi-directional QoS requirement information is determined, obtained or identified based on information in a data packet received by the transmitting end from a higher layer.

20. A receiving end device, comprising a processor and a memory, wherein the memory is configured to store a computer program, and the processor is configured to call the computer program stored in the memory and run the computer program, wherein the computer program, when run by the processor, causes the receiving end device to perform:
performing a first operation according to bi-directional quality of service (QOS) requirement information on a sidelink;
wherein the first operation comprises at least one of: determining a packet delay budget (PDB) of a reverse link, adjusting the PDB of the reverse link, determining a PDU set delay budget (PSDB) of the reverse link, adjusting the PSDB of the reverse link, determining a remaining delay, determining a remaining delay of the reverse link, deleting packets, recommending a PSDB of a forward link, recommending a PDB of the forward link, adjusting a selected resource, adjusting a selected resource set, selecting a transmission resource, selecting a transmission resource set, recommending an optional resource for a transmitting end, recommending an optional resource set for the transmitting end, triggering feedback, performing feedback, obtaining or determining time information, obtaining or determining delay information, or obtaining or determining auxiliary information.
